(19) United States
(12) Patent Application Publication
(10) Pub. No.: US 2004/0030628 A1
(43) Pub. Date: Feb. 12, 2004

(54) Asset management support system and method

(76) Inventors: Masanori Takamoto, Hitachi (JP); Asako Koyanagi, Hitachi (JP); Shigeru Kawamoto, Hitachi (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/455,442

(22) Filed: Jun. 6, 2003

(30) Foreign Application Priority Data
Jun. 7, 2002 (JP) 2002-166451
Jun. 2, 2003 (JP) 2003-156332

(51) Int. Cl. G06F 17/60

(52) U.S. Cl. 705/36

(57) ABSTRACT

The system comprises a risk allocation elation display unit that displays the relations between risk allocations of formers and latters, dependent on the decision of the formers and the decision of the latters, and the returns in a multi-dimensional format; and a risk allocation relation selection unit that accepts a user selection entry for one or more relations. The system further comprises an asset value simulation unit allowing a user to enter a management plan change rule, based on a difference between the risk allocation relations and actual relations, for a management plan satisfying the risk allocation relation selected by the user through the risk allocation relation selection unit and that presents an asset value transition that would result when management is done based on the management plan change rule.

### BACKGROUND OF THE INVENTION

The present invention relates to an asset management technology.

Conventionally, an investment amount allocation method based on a variance-covariance model has been available for use as a method for asset allocation. The contents are described, for example, in “The Portable Financial Analyst” by M. Krizman, pp. 164-175, Nihon Keizai Shimbun Inc., 2001.

A step-by-step method composed of stages from asset allocation to portfolio optimization is usually used as an investment status determination sequence from the determination of an asset allocation outline to the details such as stock selection. The contents are described, for example, “Security Investment” by Shigeki Sakakibara and his three colleagues, pp. 460-483, Nihon Keizai Shimbun Inc., 2001.

On the other hand, there is another asset management method with emphasis on the allocation of acceptable risks by various asset types. The contents are described, for example, in “Special Topic: Risk Budgeting” Security Analyst Journal, pp.4-46, Volume 39, Number 4 (2001).

In a mean variance model, the degree of risk aversion (or tolerance) with respect to the return, the so-called a risk aversion level (or risk tolerance), is set to decide an optimal investment ratio. This risk aversion level (or risk tolerance) is included in a utility function that is maximized to calculate the investment ratio. However, it is usually difficult for a user to know or to appropriately set the numerical value of his or her risk tolerance in advance.

In addition, performing asset allocation for benchmark assets during asset allocation and allocating an investment ratio to active management after asset allocation would mutually affect the risk/return relation. Therefore, the decision of the optimal investment ratio, that is, the creation of the optimal portfolio, requires repetition and adjustment. In addition, it is difficult to form the consistent image of the risk/return relation during portfolio creation. That is, it is difficult to predict a change in the risk-to-return relation that indicates how the expected return is changed by how the risk is accepted.

On the other hand, when risk allocation corresponding to an investment ratio is defined as the optimal allocation state of risk, the conventional investment ratio optimal allocation may be interpreted as the risk optimal allocation, and portfolio management may be done from the viewpoint of risk allocation. However, even in that case, the calculation of maximizing the utility function by setting the risk aversion level is necessary. In addition, in the asset allocation stage and the investment ratio decision stage in which the ratio of investment in active management assets is decided, it is difficult to consistently know the dynamic relation of return/risk tradeoff. In this case, the problem that the calculation load is high and the problem that it is difficult to consistently know the risk/return relation are not solved.

In addition, there is a problem that, although the calculation of the optimal allocation state is theoretically possible, the calculation is not practical. As a matter of fact, when selecting asset management trustees in practice, there are scores to hundreds of asset management institutions that are candidates for management trustees. Therefore, it is not realistic to evaluate and study all the combinations of management trustee period for deciding the investment ratio. On the other hand, reducing the number of candidates based only on the management result of each management trustee institution involves a danger of compromising the risk distribution effect achieved by combining a plurality of management trustee institutions.

### SUMMARY OF THE INVENTION

It is an object of the present invention to provide a technology for supporting the efficient decision of asset types and their investment ratios in asset management and a detailed method for managing the assets while considering a change in the risk allocation relation between formers and latters.

The characteristics of the present invention are described in the claims. For example, one of the characteristics of the present invention is that an asset management support system, wherein the system supports asset management including a decision of asset types and investment ratios thereof and a decision of a detailed method for managing assets, comprises risk allocation relation display means for displaying relations between risk allocations of formers and latters, dependent on a decision of the formers and a decision of the latters, and returns in a multi-dimensional format; and risk allocation relation selection means for accepting a user's selection that selects one or more of the relations.

Another characteristic of the present invention is that the system further comprises asset value simulation means that allow a user to enter a management plan change rule, based on a difference between the risk allocation relations and actual relations, for the management plan that satisfies the risk allocation relation selected by the user through the risk allocation relation selection means and that presents an asset value transition that would result when management is done based on the management plan change rule.

A still another characteristic of the present invention is that, for example, when the decision of the formers and the decision of the latters are a decision of allocation of benchmark assets and a decision of allocation of benchmark assets that are to be allocated to active management assets, the asset management support system is a risk allocation optimization system wherein the risk allocation relation display means display the relations between benchmark risk allocations and active risk allocations, dependent on the decision of the formers and the decision of the latters, and the returns in a multi-dimensional format so that the user can create an asset management plan based on a desired risk allocation status.

A still another characteristic of the present invention is that, for example, when the decision of the formers and the decision of the latters are a decision of allocation of benchmark assets and a decision of allocation of benchmark assets that are to be allocated to active management assets, the asset management support system is a risk allocation optimization system comprising means for analyzing the management results of a plurality of active management assets that are candidates for the active management assets and for displaying the result; and means for selecting active management assets, to which allocation is made, for use as input information to risk allocation calculation means.

A still another characteristic of the present invention is that the asset management support system is a risk allocation optimization system comprising asset value simulation means for presenting an asset value transition that would result when rebalancing is done according to a management plan change rule wherein the management plan change rule, based on a change that would be produced in the risk allocation relation during production run, is a management plan change rule specified for the benchmark asset allocation plan and the active management asset allocation plan that satisfy the risk allocation relation selected by the user through the risk allocation relation selection means.

The above-described characteristics and other characteristics of the present invention will be described below more in detail.

The other objects, characteristics, and advantages of the present invention will become apparent from the embodiments of the present invention described below with reference to the attached drawings.

### BRIEF DESCRIPTION OF THE DRAWINGS

FIG. 1 is a block diagram showing an example of the configuration of a system that implements the present invention.

FIG. 2 is a flowchart showing the processing procedure executed by the means in FIG. 1.

FIG. 3 is a block diagram showing the configuration of a system used in an embodiment including asset value simulation means.

FIG. 4 is a flowchart showing the processing procedure executed by the means in FIG. 3.

FIG. 5 is a flowchart showing the details of the flowchart in FIG. 2.

FIG. 6 is a flowchart showing the details of the flowchart in FIG. 4.

FIG. 7 is a diagram schematically showing an example of statistical data on value fluctuations in benchmark assets.

FIG. 8 is a diagram schematically showing an example of statistical data on value fluctuations in active management assets.

FIG. 9 is a diagram showing an example of the display of a multi-dimensional map output by risk allocation relation display means.

FIG. 10 is a diagram showing an example of the display of portfolio information output by portfolio information display means.

FIG. 11 is a diagram showing an example of the display of portfolio information and the entry of a management plan change rule.

FIG. 12 is a diagram showing an example of the display of an asset value transition result calculated by asset value simulation means.

FIG. 13 is a block diagram showing an example of system configuration when the present invention is implemented on a network.

FIG. 14 is a block diagram showing the configuration of a system used in an embodiment including statistical data analysis means.

FIG. 15 is a flowchart showing the processing procedure executed by the means in FIG. 14.

FIG. 16 is a diagram showing an example of the display of statistical data analysis.

FIG. 17 is a block diagram showing the configuration of a system used in an embodiment including constraint accepting analysis means.

FIG. 18 is a flowchart showing the processing procedure executed by the means in FIG. 17.

FIG. 19 is a block diagram showing the configuration of a system used in an embodiment including estimated return calculation means.

FIG. 20 is a flowchart showing the processing procedure executed by the means in FIG. 19.

FIG. 21 is a diagram showing an example of the display of a multi-dimensional map output by risk allocation relation display means.

FIG. 22 is a diagram showing an example of the comparative display of portfolio information output by portfolio information display means.

FIG. 23 is a diagram showing an example of the comparative display of an asset value transition result calculated by asset value simulation means.

FIG. 24 is a flowchart showing the processing procedure executed by the means in FIG. 1 when the return is the rate of change in a difference between the total assets and the total debts.

FIG. 25 is a block diagram showing the configuration of a system used in an embodiment including cost data storage means.

FIG. 26 is a block diagram showing an example of the hardware system of an information processor used in asset management support according to the present invention.

### DESCRIPTION OF THE EMBODIMENTS

The present invention relates to a method and system for supporting an investor or a management trustee in doing asset management. That is, the present invention does asset management for an investor or a management trustee with the aim of obtaining returns while reducing risk by efficiently making allocation to benchmark asset values that vary on a daily basis or by appropriately selecting management trustees and active portfolios. The present invention provides a technology for supporting such asset management by using information processors.

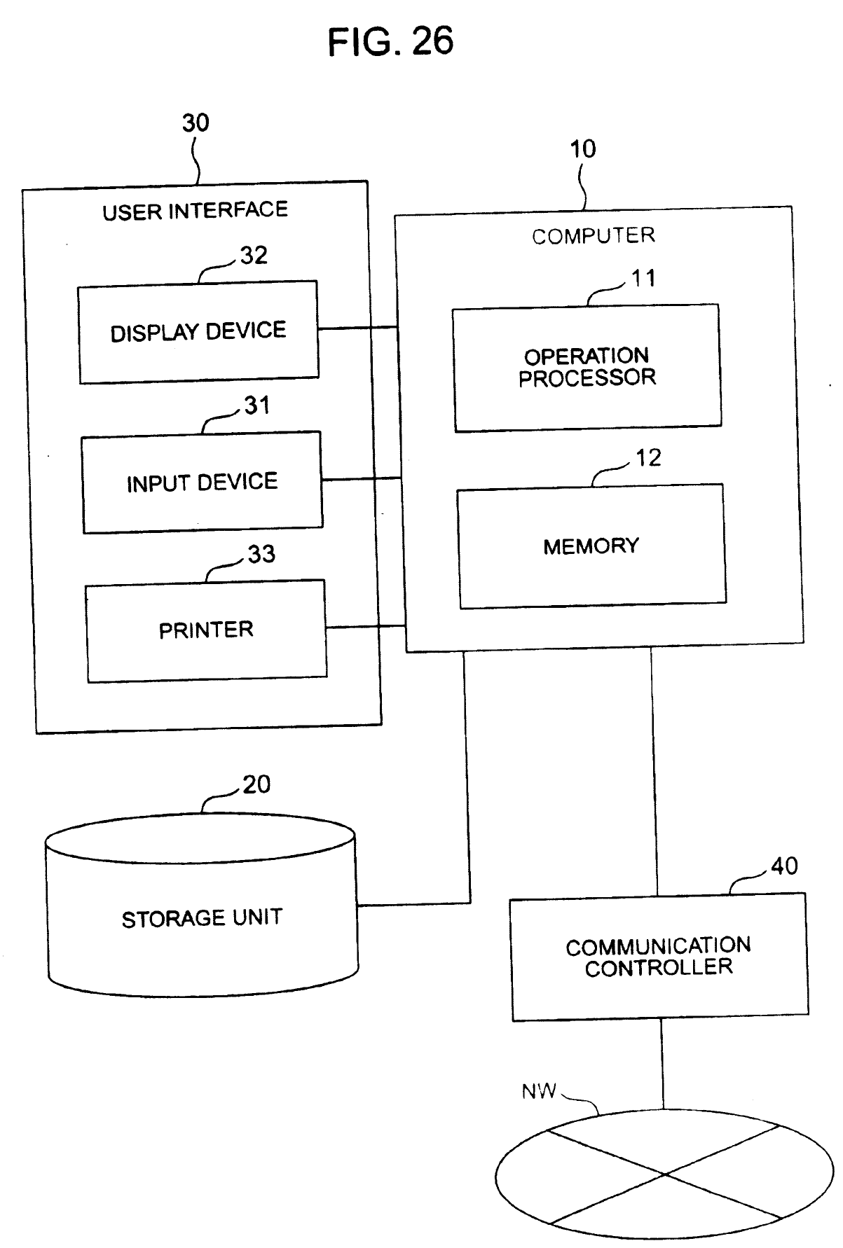

FIG. 26 shows an example of the hardware system of an information processor used for asset management support according to the present invention. The information processor shown in FIG. 26 comprises a computer 10, a storage unit 20, a user interface 30, and a communication controller 40. The computer 10 comprises an operation processor 11 and a memory 12. This operation processor 11 executes programs loaded in the memory 12 to do various asset management functions that will be described later. The storage unit 20 stores programs to be executed by the operation processor 11, data to be used in the operation, and so on. The user interface 30 comprises an input device 31, a display device 32, and a printer 33.

An asset management system according to the present invention may be implemented by one information processor. However, it is to be understood that the present invention is not limited to this configuration. A plurality of information processors may be used to allow different information processors to share the task by dividing a plurality of asset management functions. Also, a plurality of information processors may be used to do parallel processing to execute the same function. In addition, a plurality of information processors may be connected via a network for processing.

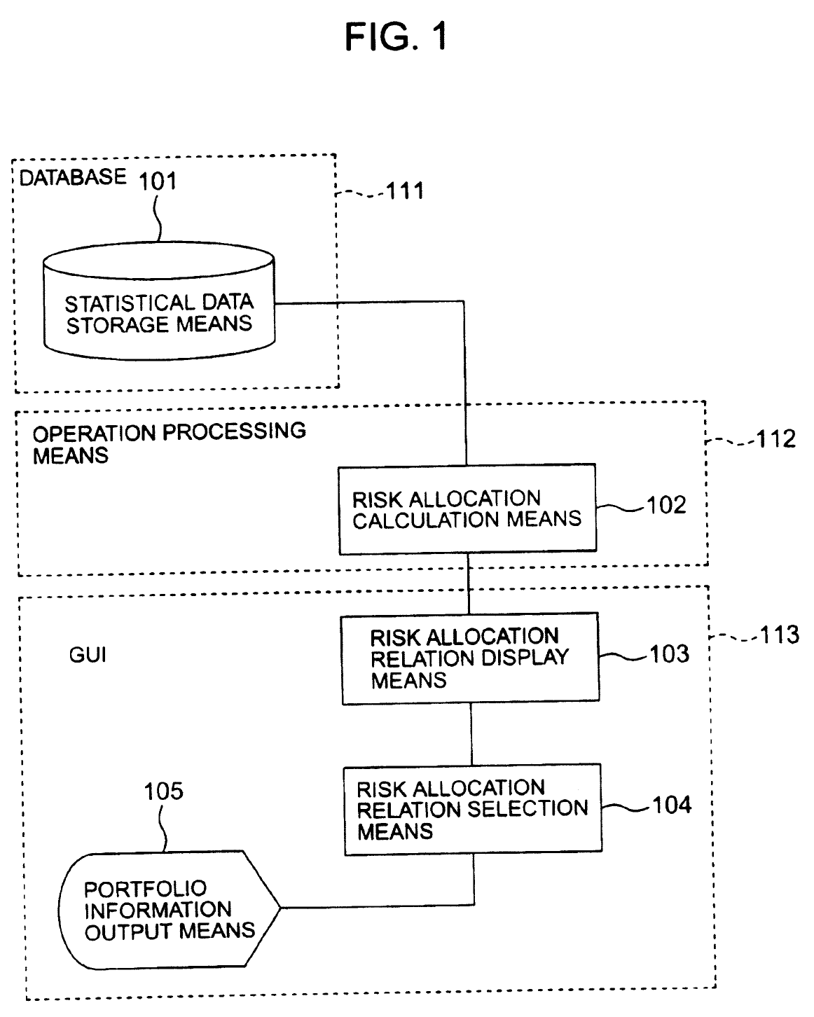

FIG. 1 shows the overview of the functional configuration of an asset management support system for supporting risk allocation optimization in a first embodiment of the present invention. The asset management support system shown in FIG. 1 is configured on the computer 10. This asset management support system has a database 111, operation processing means 112, and graphical user interface (GUI) 113 as the basic function it implements.

The storage unit 20 stores statistical data to be used in operation processing. This statistical data is updated as necessary and is managed so that the data may be used by various programs, which will be described later, in the operation processor 11 for supporting asset management. Therefore, the storage unit 20 functions as statistical data storage means 101. Statistical data on return fluctuations for benchmark assets and active management assets is stored, for example, as statistical data on the price fluctuations of the assets. Here, a benchmark is an earning rate criterion for comparing asset management results. A benchmark asset is an asset corresponding to the index. For example, benchmark assets are average and typical asset types in the market, that is, home stocks, foreign stocks, home bonds, and foreign bonds Benchmark assets may include substitute assets, which have a profit-earning property different from that of component assets, by combining benchmark assets, other securities, and securitized assets under a particular investment strategy. An active management asset is an asset that is managed actively with the aim of obtaining a return higher than the market average. A return means an earning rate. A benchmark return means an average return (=earning rate) of the whole assets (market). A benchmark risk refers to a risk measure for a benchmark return. This may be referred to as the risk of assets. A typical risk measure is a standard deviation. An active return means the difference between the earning rate obtained by active management and the average earning rate of the market; more specifically, it is defined as the difference between the return of active management assets and the return of the benchmark. An active risk refers to the risk measure for an active return.

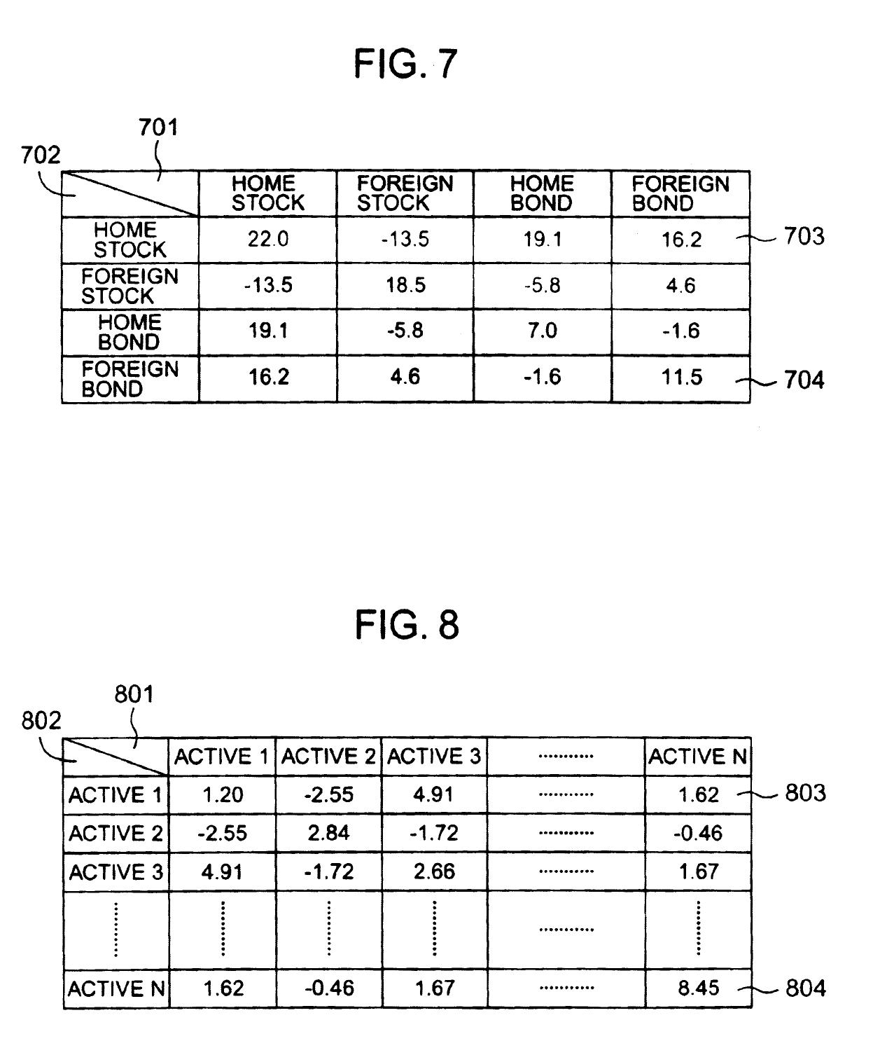

FIG. 7 and FIG. 8 show tables containing examples of the statistical data. FIG. 7 shows an example of statistical data on value fluctuations in benchmark assets. Data shown in FIG. 7 is the variance-covariance matrix of the return time-series of benchmark assets 701 and 702. Here, for example, the numeral 704 indicates a variance value. The numeral 703 indicates a covariance value. In the example shown in FIG. 7, home stocks, foreign stocks, home bonds, and foreign stocks are assets to be managed.

FIG. 8 shows an example of statistical data on value fluctuations in active management assets. Data shown in FIG. 8 is a variance-covariance matrix of the return time series of benchmark assets 801 and 802. Here, for example, the numeral 804 indicates a variance value. The numeral 803 indicates a covariance value. In the example shown in FIG. 8, a plurality of management methods, active 1 to active N, are targets.

The present invention may also be applied when the return is treated as the growth rate of a surplus that is the difference between the total asset amount and the total debt amount.

The CPU 11 uses the function of the database 111 to expand a part or all of statistical data into the memory 12 for data processing. The database 111 manages, for example, past return data on benchmark assets and active management assets. This data is stored in the statistical data storage means 101.

The operation processing means 112 is a function that is implemented by the CPU 11 executing a program and that executes operation processing on data for asset management. The function includes risk allocation calculation means 102 that is a function for executing typical operation.

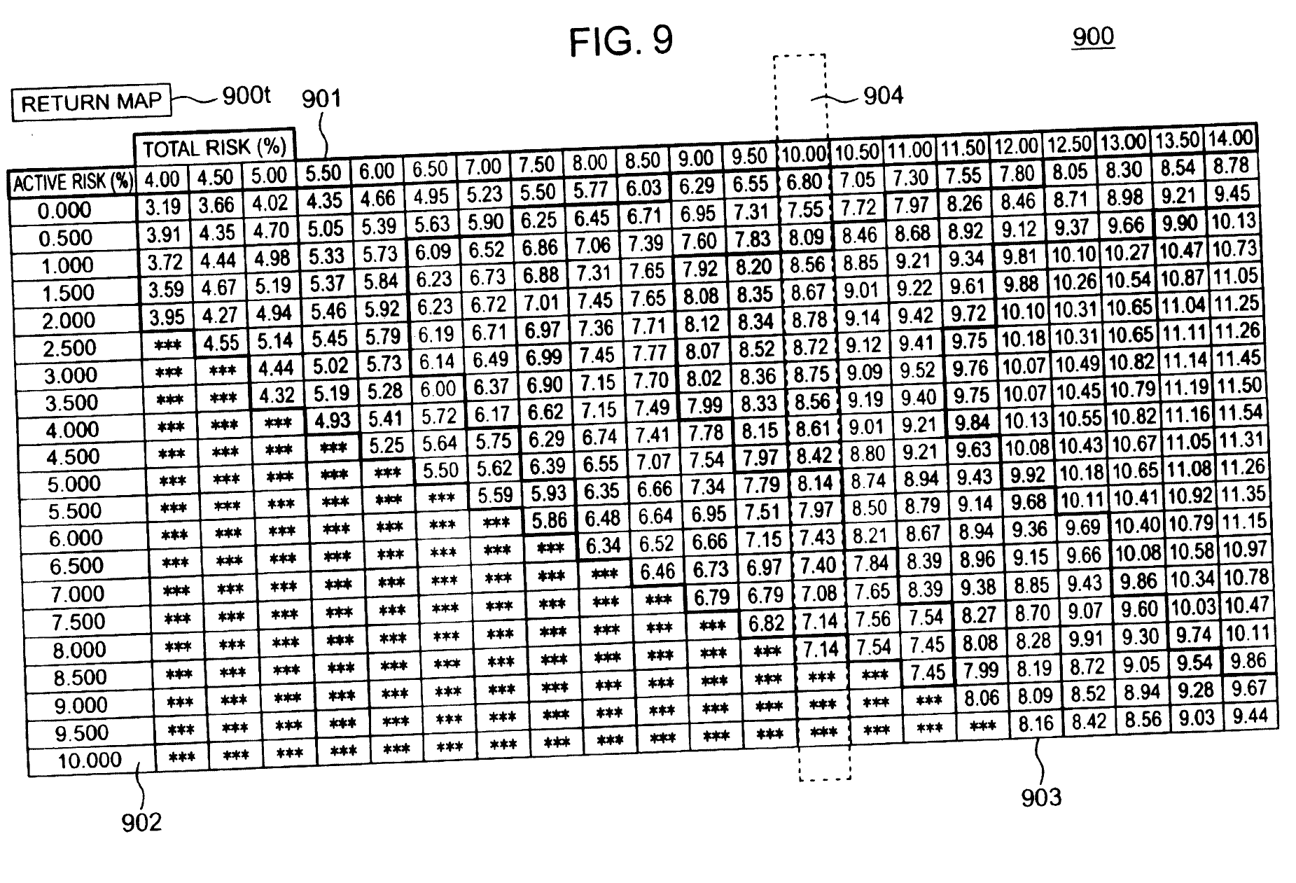

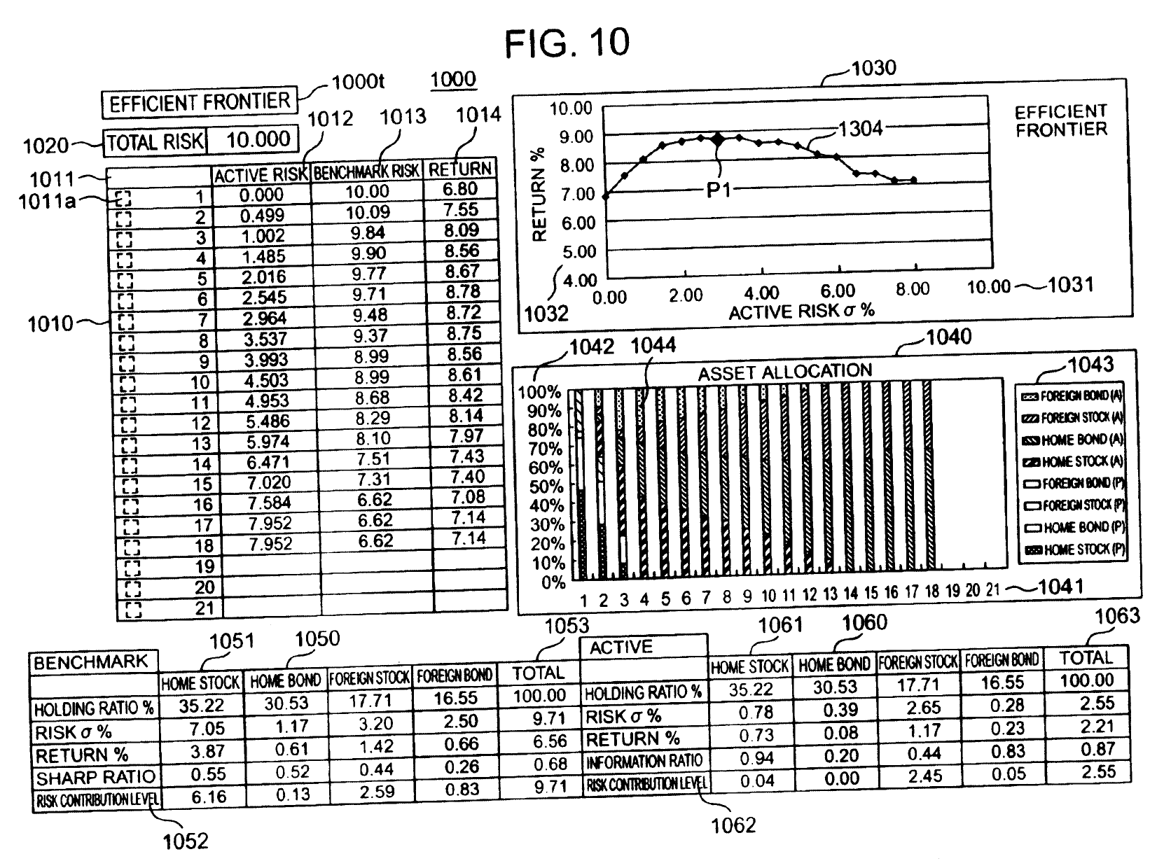

The GUI 113 is a virtual device implemented by the user interface 30 and the computer 10 described above. This GUI 113 displays information to the user, for example, displays processing results produced by the operation processing means 112, and accepts the entry of instructions from the user. From the viewpoint of the relation of processing contents, the GUI 113 functions, for example, as risk allocation relation display means 103, risk allocation relation selection means 104, and portfolio information output means 105. The risk allocation relation display means 103 is implemented by a program that displays calculation results to the user. This risk allocation relation display means 103 creates a return map, such as the one shown in FIG. 9 that will be described later, and displays it on the display device 32. The risk allocation relation selection means 104 is implemented by a program that accepts a selection entered by the user from the input device 31 based on the display on the display device 32. This risk allocation relation selection means 104 accepts a selection of risk allocation relation from the return map shown in FIG. 9. The portfolio information output means 105 is implemented by a program that displays detailed information on a user-selected risk allocation relation accepted by the risk allocation relation selection means 104, that is, portfolio information, on the display screen of the display device 32. As shown in FIG. 10 that will be described later, this portfolio information output means 105 divides the detailed information on user-selected risk allocation relation into a plurality of areas and displays it as a list.

Of course, when the division amount is too large, the information cannot be displayed as a list.

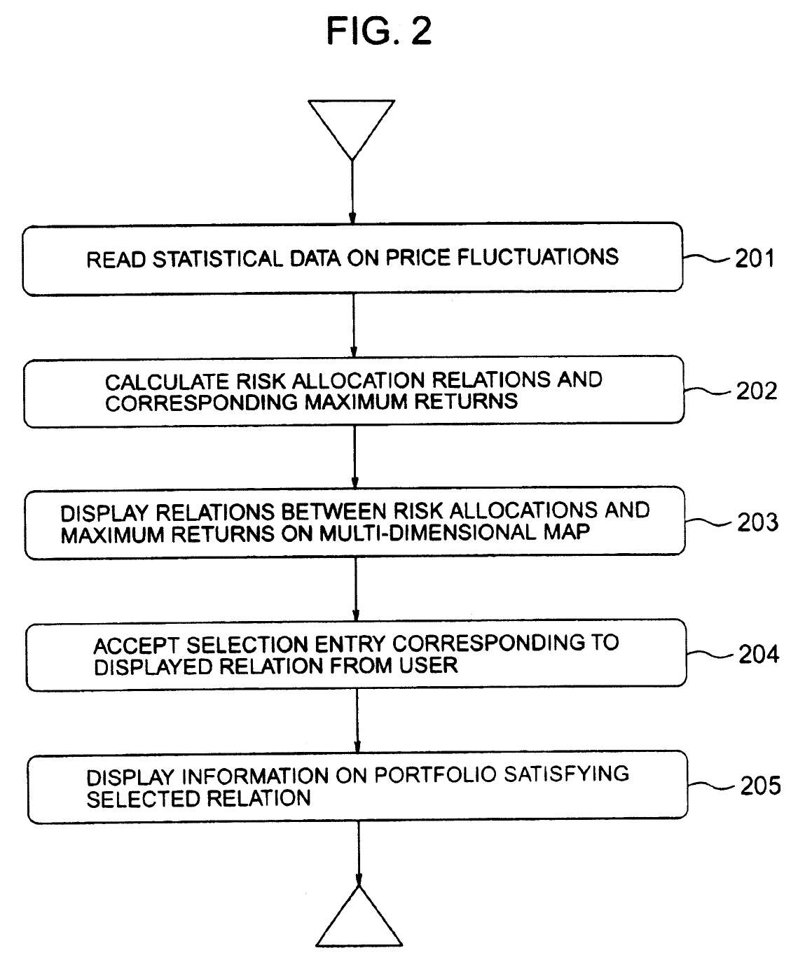

Next, FIG. 2 shows the outline of the processing procedure executed by the operation processor 11 in the asset management support system shown in FIG. 1. The operation processor 11 reads statistical data on price fluctuations in the assets from the statistical data storage means 101 into the memory 12 (step 201). The operation processor 11 functions as the risk allocation calculation means 102, calculates the risk allocation relation of each asset and the corresponding maximum expected return based on the statistical data that is read (step 202), and stores the calculation result in the memory 12. The risk allocation relation display means 103 prepares for displaying the relations between the calculated risk allocations stored in the memory 12 and the expected maximum returns as a multi-dimensional return map such as the one shown in FIG. 9 and displays the obtained result on the screen (step 203). The risk allocation relation selection means 104 displays an entry, selected by the user from one or more risk allocation/return relations displayed on the map, on the display screen and accepts an entry corresponding to the display screen that is entered from the input device 31 (step 204). When the selection entry is accepted, the portfolio information output means 105 outputs portfolio information, corresponding to the risk/return relation, on a separate display screen such as the display screen shown in FIG. 10 (step 205).

Because the risk allocation relations and the maximum expected returns are shown in this embodiment, the user is informed of the expected return amount corresponding to an acceptable risk for various risk relations. Therefore, the overall outlook on the risk-to-return relation, which has not been clear, is provided clearly to the user. In addition, detailed portfolio information may be displayed from each risk allocation relation through an easy operation. Therefore, the user is provided not only with the overall outlook on the risk-to-return relations but also with detailed information. Therefore, the user can easily determine the risk and return of asset management.

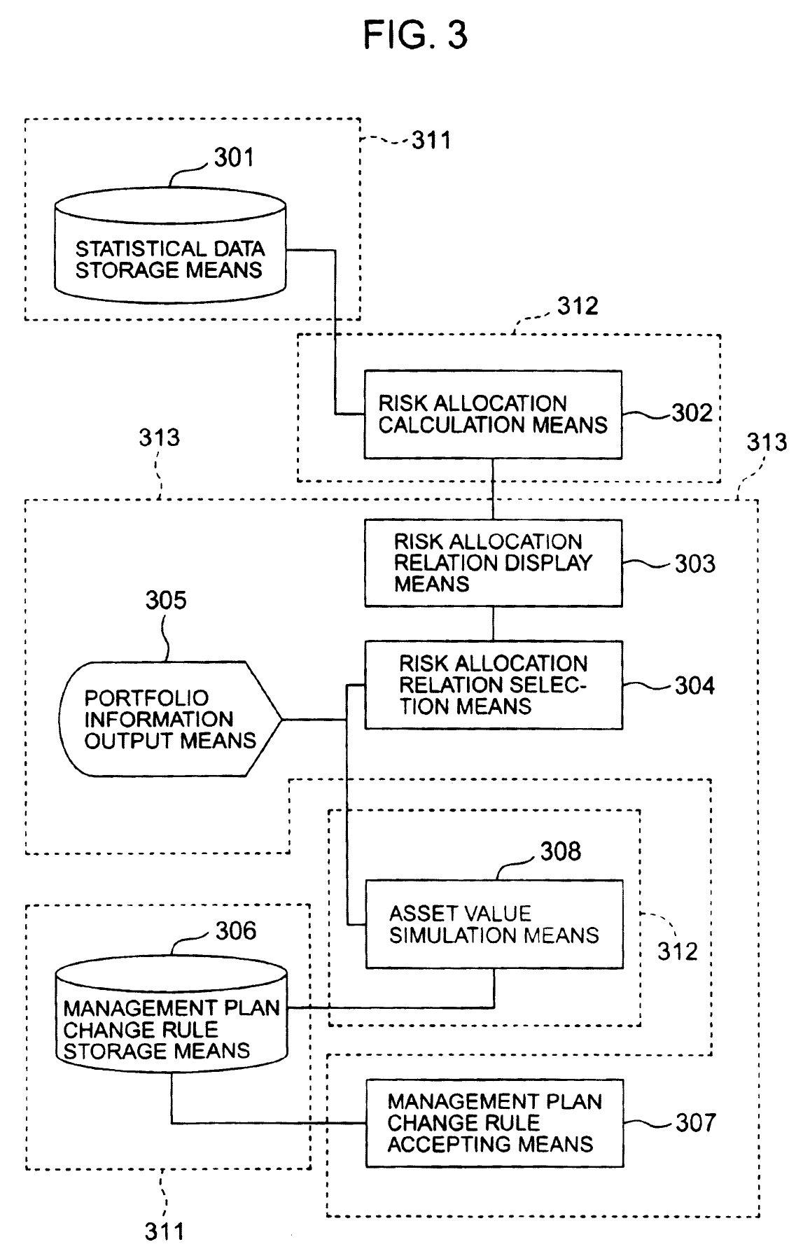

Next, a second embodiment of the present invention will be described. In the second embodiment of the present invention, transition information on asset values may be included in the information output to the portfolio information output means 105. FIG. 3 shows an example of the configuration of this embodiment.

An asset management system in this embodiment is the asset management support system shown in FIG. 1 to which a function for indicating a management transition and a function for changing a management plan are added. That is, the asset management support system in this embodiment is configured on the computer 10 in the same as the asset management support system shown in FIG. 1. As shown in FIG. 3, the asset management system in this embodiment comprises a database 311, operation processing means 312, and a graphical user interface (GUI) 313 as the basic function it implements. The database 311, operation processing means 312, and graphical user interface (GUI) 313 are the same as those of the database 111, operation processing means 112, and GUI 113 in the first embodiment except that the functions are added. On the other hand, the information processor shown in FIG. 26 may be used as the hardware resource. The relation with the information processor is the same as that in the first embodiment and, therefore, its description is omitted.

The database 311 comprises statistical data storage means 301 corresponding to the statistical data storage means 101 shown in FIG. 1 and management plan change rule storage means 306. The management plan change rule storage means 306 stores user-entered simulation periods and management plan change rules in the storage unit 20. The operation processing means 312 comprises a risk allocation calculation means 302 corresponding to the risk allocation calculation means 102 shown in FIG. 1 and asset value simulation means 308. The asset value simulation means 308 calculates the asset value transition of a user-selected portfolio according to a condition stored in the management plan change rule storage means 306 and displays the result on the display device 32. The GUI 313 comprises risk relation display means 303 corresponding to the risk relation display means 103 shown in FIG. 1, risk allocation relation selection means 304 corresponding to the risk allocation relation selection means 104 shown in FIG. 1, portfolio information output means 305 corresponding to the portfolio information output means 105 shown in FIG. 1, and management plan change rule accepting means 307. The management plan change rule accepting means 307 accepts the entry of a simulation period and a management plan change rule entered by the user from the input device 31 in response to the display on the display device 32. These means are implemented by the operation processor 11 executing programs.

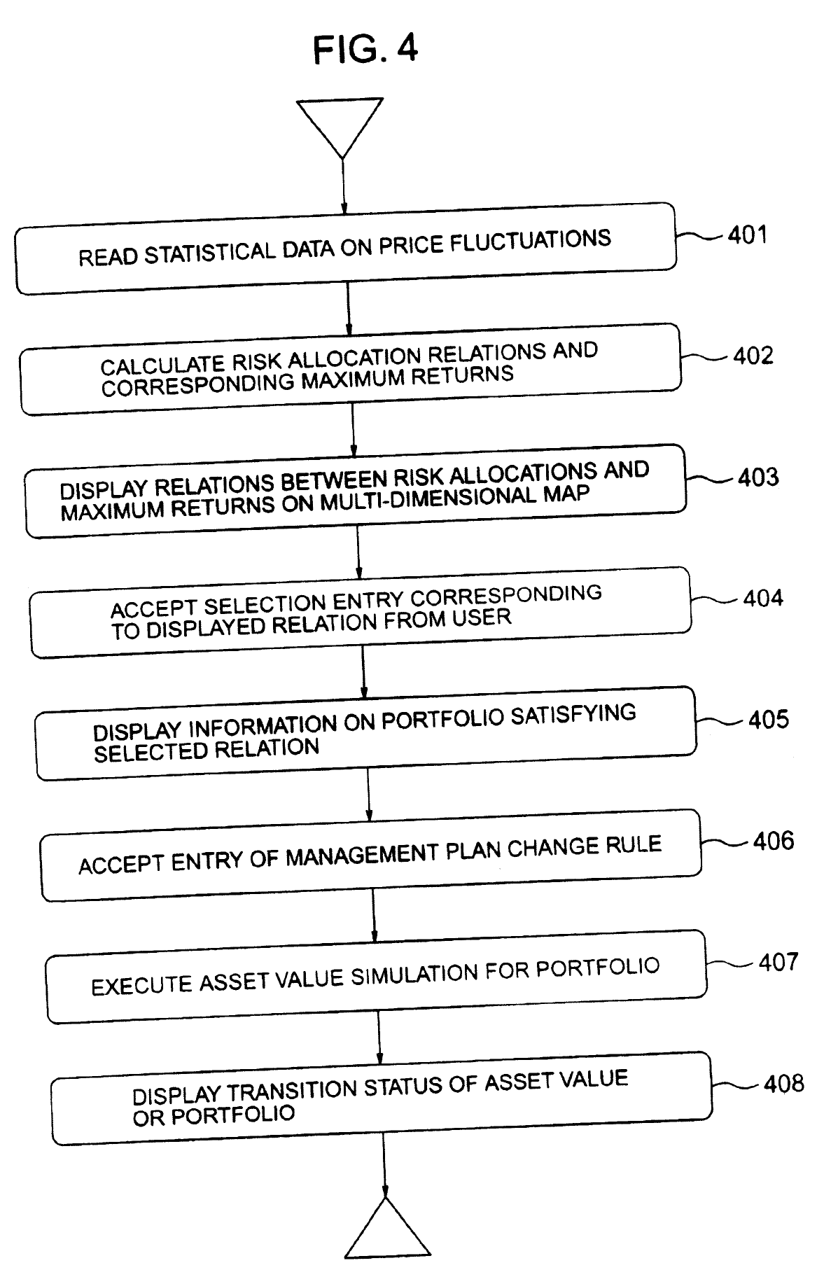

FIG. 4 shows the processing procedure executed by the means of the asset management support system in FIG. 3. The processing is implemented by the operation processor 11 executing the programs, loaded into the memory 12, in the computer 10 as in the first embodiment described above. The operation processor 11 executes steps 401-405 shown in FIG. 2 described above. The processing of steps 401-405 is the same as that of steps 201-205 shown in FIG. 2. Therefore, the description of the processing of these steps is omitted. In this embodiment, steps 406-408 are further executed.

The operation processor 11 functions as the management plan change rule accepting means 307 and, with the use of the display device 32 and input device 31, accepts the entry of a management plan change rule, such as a portfolio change condition, entered in response to the screen display on the display device 32. The accepted management plan change rule is stored in the storage unit 20 by the management plan change rule storage means 306 (step 406).

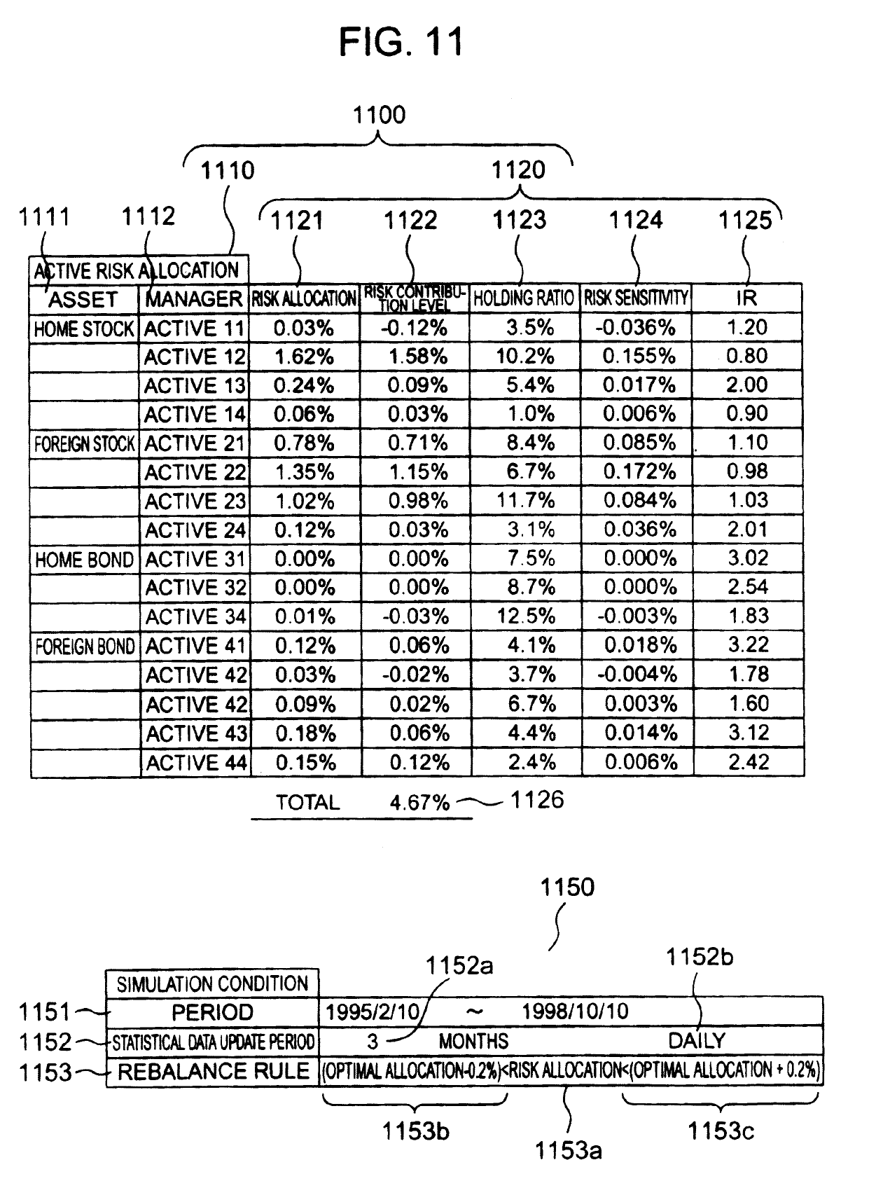

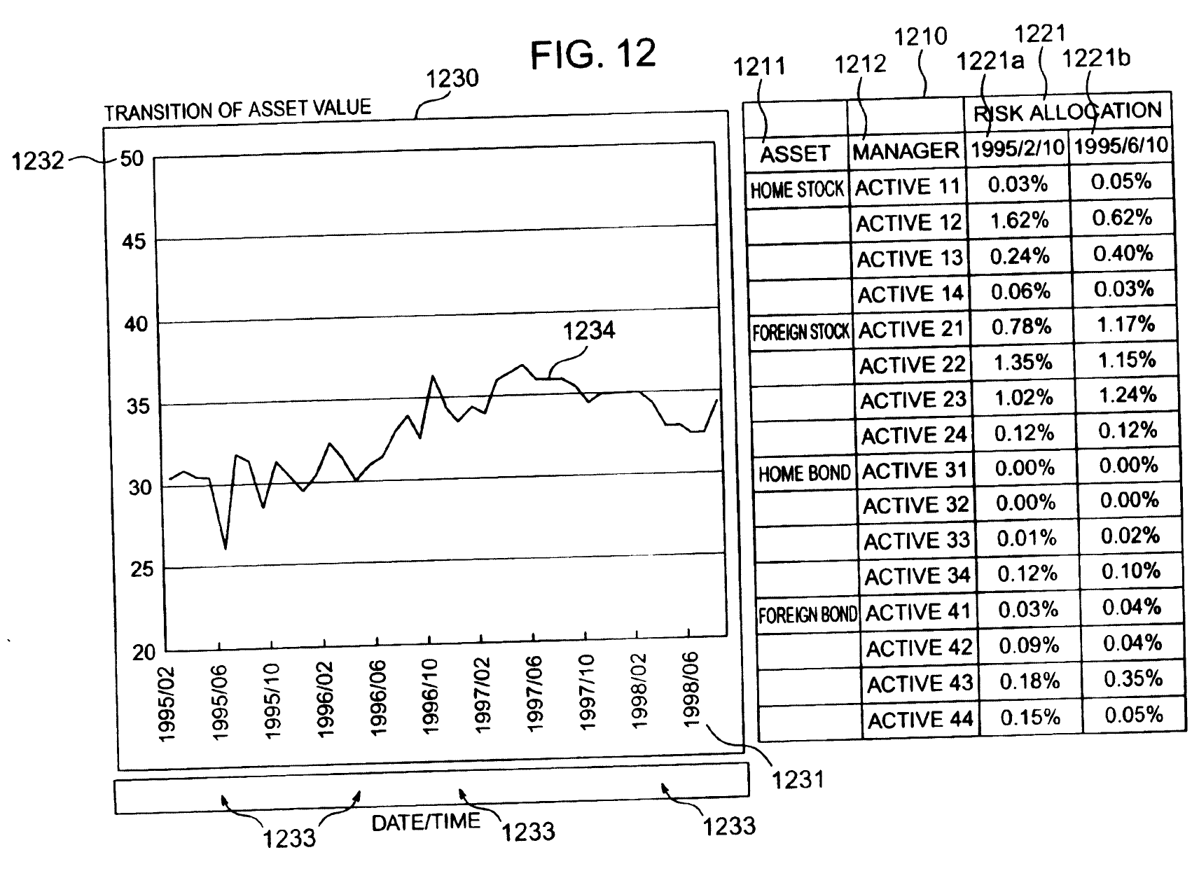

The risk allocation relation selection means 304 accepts a selection entered by the user (step 404) The portfolio information output means 305 displays portfolio information in response to the selected entry. For example, it displays the screen, such as the one shown in FIG. 10 and FIG. 11 that will be described later, on the display device 32 (step 405). For the displayed portfolio, the asset value simulation means 308 executes the simulation of the portfolio asset value that is assumed when the asset is managed according to the management plan change rule described above for the specified period (step 407). The portfolio information output means 305 displays the simulation result as the transition status of the portfolio asset value, for example, as shown in FIG. 12 (step 408).

As described above, this embodiment supports the user in asset management in the same way the first embodiment does. In addition, the ability to enter a management plan change rule allows the user to view the result that would be produced when the management method is changed.

Next, the asset management systems in the first embodiment and the second embodiment described above and the asset management method will be described more in detail.

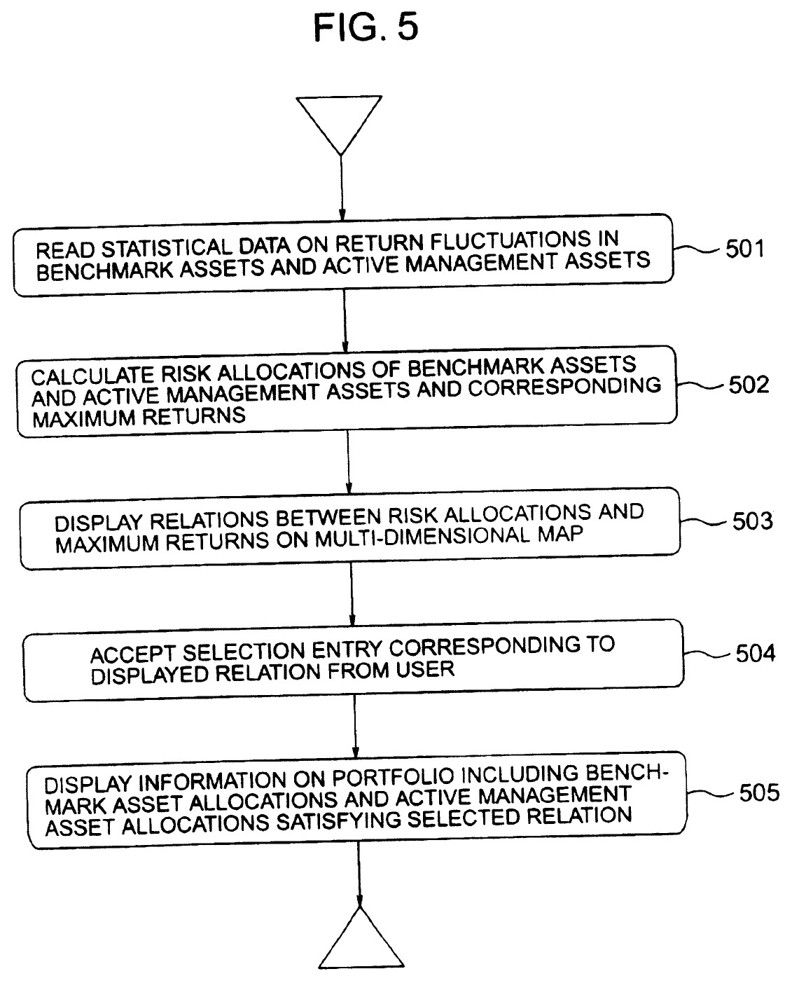

FIG. 5 shows a specific processing procedure executed in this embodiment by the means shown in FIG. 1. This figure shows an example of the processing procedure shown in FIG. 2 in which statistical data read in step 201 is assumed specifically to be statis-tical data on the return fluctuations in benchmark assets and active management assets and in which the risk allocation relations and the maximum expected returns calculated in step 2 are assumed to be the risk allocation relations and the expected maximum returns of benchmark assets and active management assets. The purpose of processing shown in this figure is to decide the ratio of investment in benchmark assets and to decide a specific method for managing the assets, that is, to decide which active manager should manage the assets using what funds and under what condition.

In FIG. 5, the risk allocation calculation means 102 reads statistical data on return fluctuations in benchmark assets and active management assets from the statistical data storage means 101 into the memory 12 (step 501). The risk allocation calculation means 102 calculates the maximum expected returns corresponding to the risk allocations of the benchmark assets and the active management assets (step 502). This calculation is executed as follows.

Expression (1) shows the calculation model for the expected returns and risks of a portfolio.

Expected return:

R=rw_{b}+αwₐ (1)

Variance of expected returns:

$${σ}_{total}^{2} = {w}_{b}^{′} {\sum }_{b} {w}_{b} + {w}_{a}^{′} {\sum }_{a} {w}_{a} \qquad ( 2 a )$$

Variance of all active returns:

$${σ}_{a}^{2} = {w}_{a}^{′} = {\sum }_{a} {w}_{a} \qquad ( 2 b )$$

R in expression (1) indicates the expected return value of a portfolio, w_{b} indicates the column vector of ratios of investment in benchmark assets, wₐ indicates the column vector of ratios of investment in active management assets, r indicates the expected return row vector of benchmark assets, and α indicates the expected active return row vector of active management assets. For example, the expected return of benchmark assets and expected active return of active management assets, which constitute r and α, may be the averages of statistical data. The estimates calculated based on financial engineering models such as the building-block method and Black-Litterman method are also available for use.

σₜₒₜₐₗ in expression (2a)2 indicates the total risk of a portfolio, and

$${\sum }_{b}$$

indicates the variance-covariance matrix of benchmark returns shown in FIG. 7. σₐ in expression (2b) indicates the total active risk of a portfolio, and □ₐ indicates the variance-covariance matrix of the active return shown in FIG. 8.

The calculation of the maximum expected return in step 502 is executed, for example, by maximizing R in expression (1) with the risk in expression (2a) and expression (2b) as the previously-specified constraint condition. Maximizing the expected return R is equivalent to determine the investment ratio vector that maximizes R. However, it is analytically difficult to maximize R in expression (1) with expression (2a) and expression (2b) as the constraint condition. Therefore, in step 502, the calculation for minimizing the total risk in expression (2a) and expression (2b) is first executed multiple times. The obtained information on solutions covering the risk allocation relations and the maximum returns is accumulated in the memory 12 of the computer 10. Based on the calculation result, a search is made for the maximum expected return satisfying the constraint condition in expression (3a) and expression (3b). The obtained maximum expected return is made to correspond to each risk allocation and stored in the memory 12.

The risk allocation relation display means 103 displays the relations between calculated risk allocations and maximum expected returns on a return map in a predetermined tabular format (step 503). The program used to create a map in a tabular format is not necessarily a program specific to this embodiment. A general-purpose spreadsheet program may be used.

FIG. 9 shows an example of return map. A return map 900 shown in FIG. 9 is an example of a multi-dimensional map. In this example, the combinations of [total risk σₜₒₜₐₗ−active risk σₐ−expected maximum return] are displayed as the risk allocation relations. This return map 900 indicates the values of maximum returns that are expected according to the risk allocation that is allocated between active risks and total risks. In this embodiment, the map is in the tabular format that is displayed as a list. If the map cannot be displayed as a list on the screen because of the display screen size, it may be scrolled. The name “Return Map” 900t is attached to the screen.

This display processing is executed by the risk allocation relation display means 103. FIG. 9 shows the result in the tabular format. That is, the total risks are arranged in the row direction (901) while the total active risks are arranged in the column direction (902). The expected maximum return corresponding to each combination is shown in the cell at the intersection of the column and the row as the element (903) of the map. Any given column indicates a return corresponding to a change in the size of active risk with the total risk fixed to a specific value. For example, in the column 904 where the total risk is 10.00%, the return values corresponding to the active risks from 0.000% to 8.5000%, acceptable in the range from the active risk 0.000% to 10.000%, are shown.

The risk allocation relation selection means 104 accepts one or more selection entries of the risk-allocation/return relations displayed on the map, which is shown in FIG. 9 as the risk allocation relation display, from the user (step 504). In the example shown in FIG. 9, one column (904) indicated by dotted lines is selected from the map. In this case, the risk allocation relation between one total risk and a plurality of different total active risks, as well as the expected maximum return corresponding to each risk allocation relation and the corresponding portfolio, are selected.

When the selection entry is accepted, the portfolio information output means 105 outputs portfolio information corresponding to the risk allocation/return relation (step 505). The portfolio information output means 105 shows detailed information on one column selected from the return map shown in FIG. 9 described above. In the example shown in FIG. 9, the column 904 corresponding to the total risk 10.000% is selected.

FIG. 10 shows an example of the portfolio information output screen. On a portfolio information output screen 1000 shown in FIG. 10, a table 1010 indicating the relation between the total risk risk allocation and returns, a total risk display area 1020 indicating the total risk, an efficient frontier display area 1030 indicating an efficient frontier, an asset allocation area 1040 indicating asset allocation, a benchmark asset detail display area 1050 indicating the detail of benchmark assets, and an active management asset detail display area 1060 indicating the detail of active management assets are arranged on the display screen of the display device 32. The name 1000t “Efficient frontier” is also displayed on the screen.

In the total risk display area 1020, one total risk value “10.000”, corresponding to one column (904) selected in FIG. 9, is displayed. In the table 1010, for the risk allocation relation of a plurality of different active risks corresponding to this total risk, the allocation identification number is displayed in 1011, the active risk is displayed in 1012, the benchmark risk is displayed in 1013, and the corresponding return value is displayed in 1014. In this example, data is displayed for the allocation identification numbers 1 to 18. In 1011, a checkbox 1011a is displayed. Upon accepting an instruction corresponding to this checkbox, a corresponding point P1 is displayed in the efficient frontier graph and, at the same time, the corresponding detail data is displayed in the benchmark asset detail display area 1050 and the active management asset detail display area 1060.

In the efficient frontier display area 1030, an efficient frontier 1034 of active risks/maximum returns is displayed with an active risk 1031 on the horizontal axis and a return 1032 on the vertical axis. This efficient frontier 1034 indicates the relation between active risks and expected maximum returns. A point on the efficient frontier 1034 each corresponds to one portfolio. In this example, a portfolio is provided assuming that the selection of risk allocation status is made with the total risk fixed.

In the asset allocation area 1040, the ratio (investment ratio) among assets for each risk allocation is represented by a component bar chart 1044. In the figure, the ratio of assets is represented by changing the hatching pattern. On the display unit, the ratio can be distinguished by colors. The horizontal axis indicates the risk allocation number 1041, and the vertical axis indicates the asset allocation ratio 1042. On the right side, the explanatory note 1043 distinguishing the assets is shown.

When one of checkboxes 1011a is selected, detailed data on the selected risk allocation, that is, the point P1 on the efficient frontier 1034, is displayed in the asset detail display area 1050 and the active management asset detail display area 1060. That is, the ratio of investment 1052 in the benchmark asset and so on are displayed in the asset detail display area 1050. More specifically, numeric values of the holding ratios, risks, returns, Sharp ratios, and risk contribution levels are displayed for the asset types 1051. In the active management asset detail display area 1060, the ratio of investment 1062 in the active management asset and so on are displayed for the asset types 1061. More specifically, the numeric value of the holding ratios, risks, returns, information ratios, and risk contribution levels are displayed.

Here, the Sharp ratio is the ratio of return to risk. That is, this is a measure representing how much risk is to be accepted to obtain the return. The information ratio is the ratio between an active return and a tracking error (standard deviation of active return). This is a measure representing how much extra risk the manager is to accept to obtain a return higher than that of the benchmark. In general, a manager achieving a higher value is thought of as an excellent manager. The risk contribution level is a value representing the contribution of the risk of each asset in the portfolio or the risk of the manager in relation to the total risk.

In addition, FIG. 11 shows detailed information 1100 on each management type of the active management assets at that point and a table 1150 used to set up a simulation condition. They are displayed on the same screen. Of course, they may be displayed on separate screens.

The detailed information 1100, which indicates active risk allocation 1110 more specifically, shows management specification information 1120 on each asset 1111 and a manager 1112 to whom the management is assigned. That is, a risk allocation 1121, risk contribution level 1122, holding ratio 1123, risk sensitivity 1124, IR 1125, as well as an active risk total 1126 that is the total active risk of the portfolio, are shown.

The table 1150 for setting a simulation condition includes the data entry fields for a period 1151, a statistical data update period 1152, and a rule for changing the portfolio composition, that is, a rebalance rule 1153. In the example shown in FIG. 11, the period from Feb. 10, 1995 to Oct. 10, 1998 is set in the period 1151. “3 months” and “daily update” are set in the statistical data update period 1152. In addition, as a rebalance rule, a condition requiring that the risk allocation 1153a be managed in the range higher than (optimal allocation−0.2%) (1153b) and lower than (optimal allocation+0.2%) (1153c), that is, a condition requiring that rebalancing be done when there is a deviation of at least ±0.2% is set. Rebalancing means that the portfolio of the optimal risk allocation is changed by re-executing optimization calculation.

The numeric values involved in calculation and setting described above are stored in the memory 12. Those numeric values are read from the memory 12 for use. This is the same as in the embodiments that will be described later.

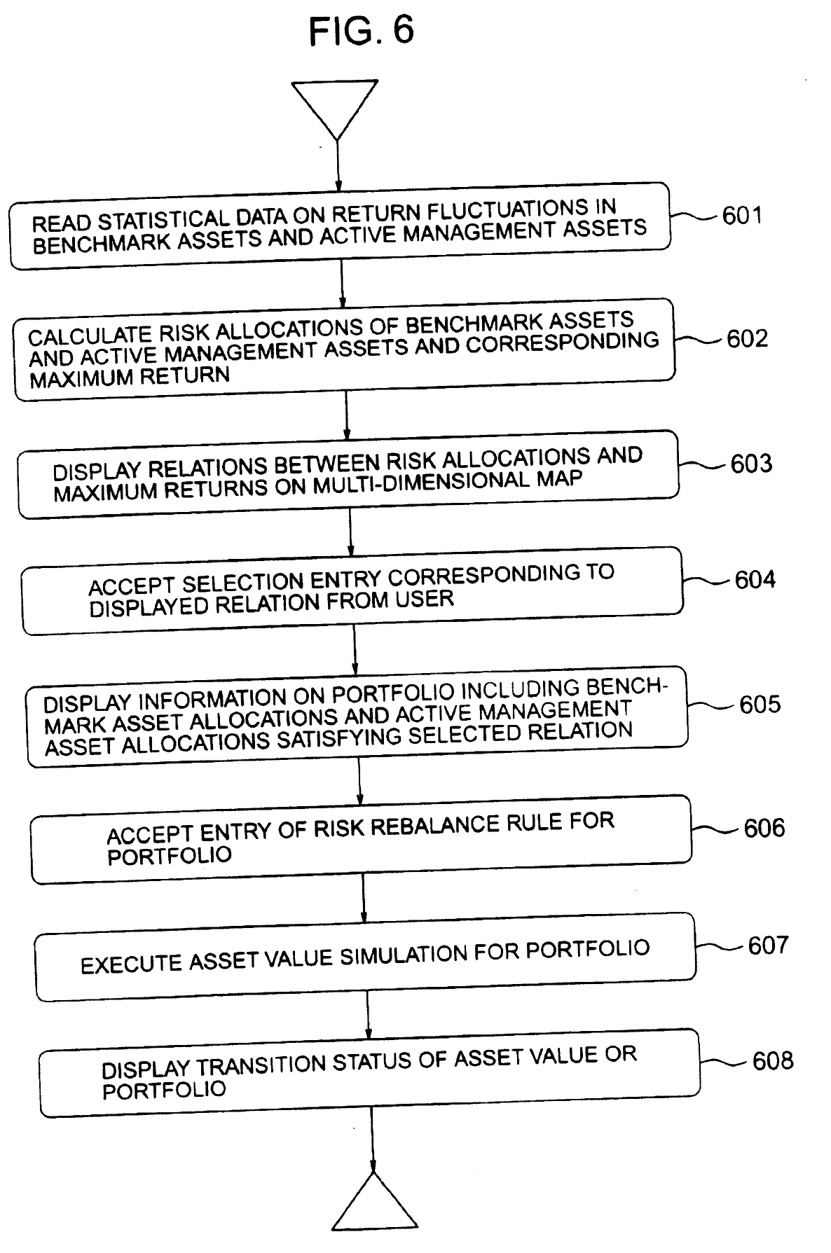

Next, the functions specific to the second embodiment of the present invention will be described more in detail. FIG. 6 shows the processing procedure executed by the means of this embodiment. Steps 601-605 in FIG. 6 are the same as corresponding steps 501-505 in FIG. 5. The following describes processing specific to this embodiment.

The management plan change rule accepting means 307 accepts the entry of a rule, such as a portfolio change condition, from the user via the input device 31 and the display device 32 (step 606). The management plan change rule storage means 306 stores the accepted management plan change rule in the storage unit 20 (step 606). For example, in this embodiment, the management plan change rule is a risk rebalance rule for the optimal risk allocation 1121 for the active management type of the portfolio as shown in FIG. 11. That is, as shown in the rebalance rule 1153 in FIG. 11, a rule is set stating that, when the active risk allocation to each active management type deviates from the current optimal risk allocation by ±0.2%, rebalancing should be done by executing optimization calculation. In FIG. 11, a rebalance rule for active risk allocation is shown as an example. Another rebalance rule may also be set by setting up a condition, for example, for a total risk or the risk management of individual active managers, according to the user's portfolio management strategy.

The asset value simulation means 308 calculates the transition of the portfolio asset value for the portfolio, selected in step 604 and displayed in step 605, based on the management plan change rule stored in the management plan change rule storage means 306 (step 607). That is, the asset value simulation means 308 calculates the transition of the portfolio asset value according to the simulation condition (period, statistical data update period, rebalance rule) shown in FIG. 11 as if the assets were managed according to the management plan change rule described above.

The portfolio information output means 305 displays the transition status of the portfolio asset value on the display device 32 (step 608). FIG. 12 shows an example of output.

In FIG. 12, a graph 1230 of portfolio asset value transition and an optimal risk allocation 1210 are displayed on the screen. In this example, they are displayed on the same screen. The horizontal axis of the graph 1230 indicates the passage of time 1231, while the vertical axis indicates the asset value 1232. The transition of the portfolio asset value is shown as a broken line 1234 in the graph 1230. Triangle marks 1233 are shown below the horizontal line. They each indicate a point in time at which recalculation is executed by applying the rebalance rule described above. In the optimal risk allocation 1210, the optimal risk allocation after recalculation at each rebalance time is shown for each active management type. That is, a manager type 1212 to which an asset 1211 is allocated and a corresponding risk allocation 1221 are displayed. Dates 1221a and 1221b are attached to the risk allocation 1212. Only two points, that is, Feb. 10, 1995 when optimization was executed and Jun. 10, 1995 when the first rebalance was executed are shown in the example in FIG. 12. Data on the risk allocation at the second and subsequent rebalances, if not included on one screen, could be displayed using a technology such as scrolling.

The configuration described above allows the management result of a created portfolio to be simulated for displaying the value transition in the visual format. In addition, the application of a rebalance rule makes it possible to change the portfolio so that the risk allocation becomes the optimal risk allocation that can prevent an active risk from increasing. That is, appropriate asset management support may be provided for the user.

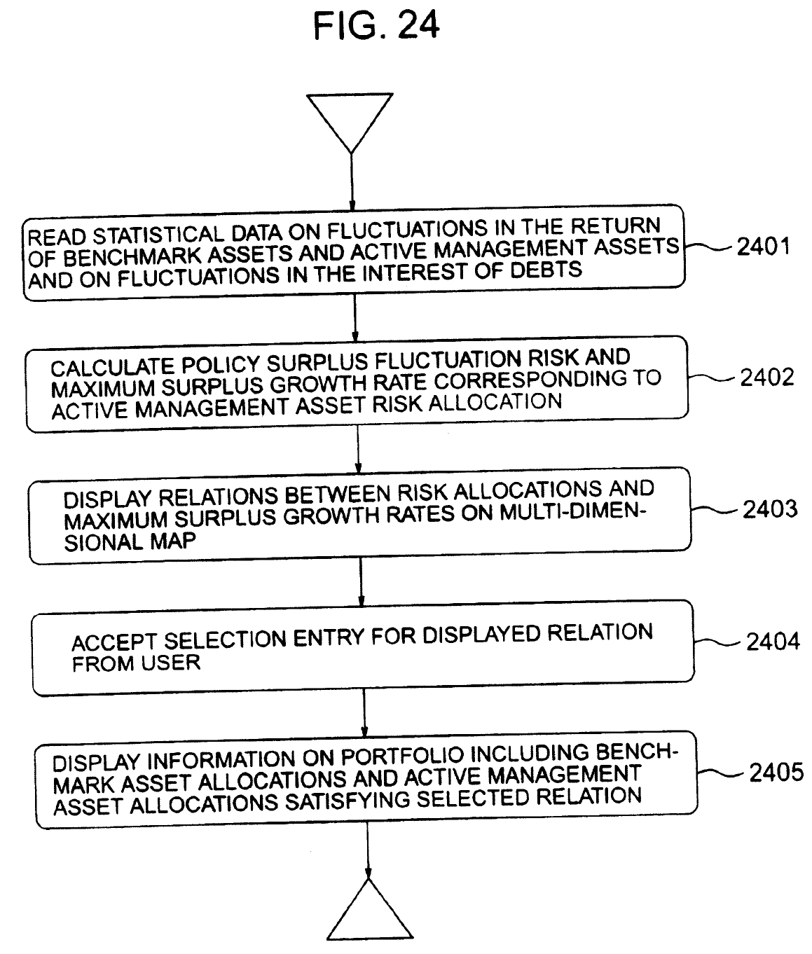

In the risk allocation relation calculation step in the embodiment described above, risk allocation may be calculated based on other indexes. The example is shown in FIG. 24. In FIG. 24, the operation processor 11 reads statistical data on fluctuations in the returns of benchmark assets and active management assets and fluctuations in the interests of debts from the storage unit 20 (step 2401). The policy surplus fluctuation risk, which is the difference between the total assets and the total debts in benchmark asset allocation, and the maximum surplus growth rate corresponding to each combination of active management risks are calculated (step 2402). Next, in the risk allocation relation display step, the maximum surplus growth rate for a combination of the total surplus fluctuation risk and the total active risk is displayed on a multi-dimensional map. (step 2403). After that, as in FIG. 5, a selection entry corresponding to the displayed relation is accepted from the user (step 2404). Information on a portfolio including the benchmark asset allocations and the active management asset allocations satisfying the selected relation is displayed (step 2405).

The risk measures σₜₒₜₐₗ and σₐ in expression (1) and expressions (2a) and (2b) are the standard deviations for benchmark returns and active returns. However, Monte Carlo simulation in which a fluctuation scenario for each return is appropriately set may be used or, by changing the formulation of the objective function, one of VaR, C-VaR, EaR, shortfall probability, SaR, and factor exposure may be used as the risk measure.

In the above embodiments, a combination of [total risk σₜₒₜₐₗ−total active risk σₐ−expected maximum return] is used as an example of the risk allocation relation. The present invention is not limited to this combination. Other examples of a multi-dimensional map will be described with reference to FIG. 21.

Any combination of three risks or return measures involved in expected maximum return calculation in step 502 may be displayed. For this purpose, display switching function 2110, 2120, and 2130 are provided on the screen. They all have a configuration in which a choice may be selected in the pull-down menu format. That is, the display switching function 2110 is used to select a first measure displayed in the row direction. The display switching function 2120 is used to select a second measure displayed in the column direction. The display switching function 2130 is used to select a third measure displayed in a displayed element part 2103. The third measure displayed in the displayed element part 2103 displays the calculation result corresponding to the combination of the first and second value of the measures corresponding to the row direction and the column direction.

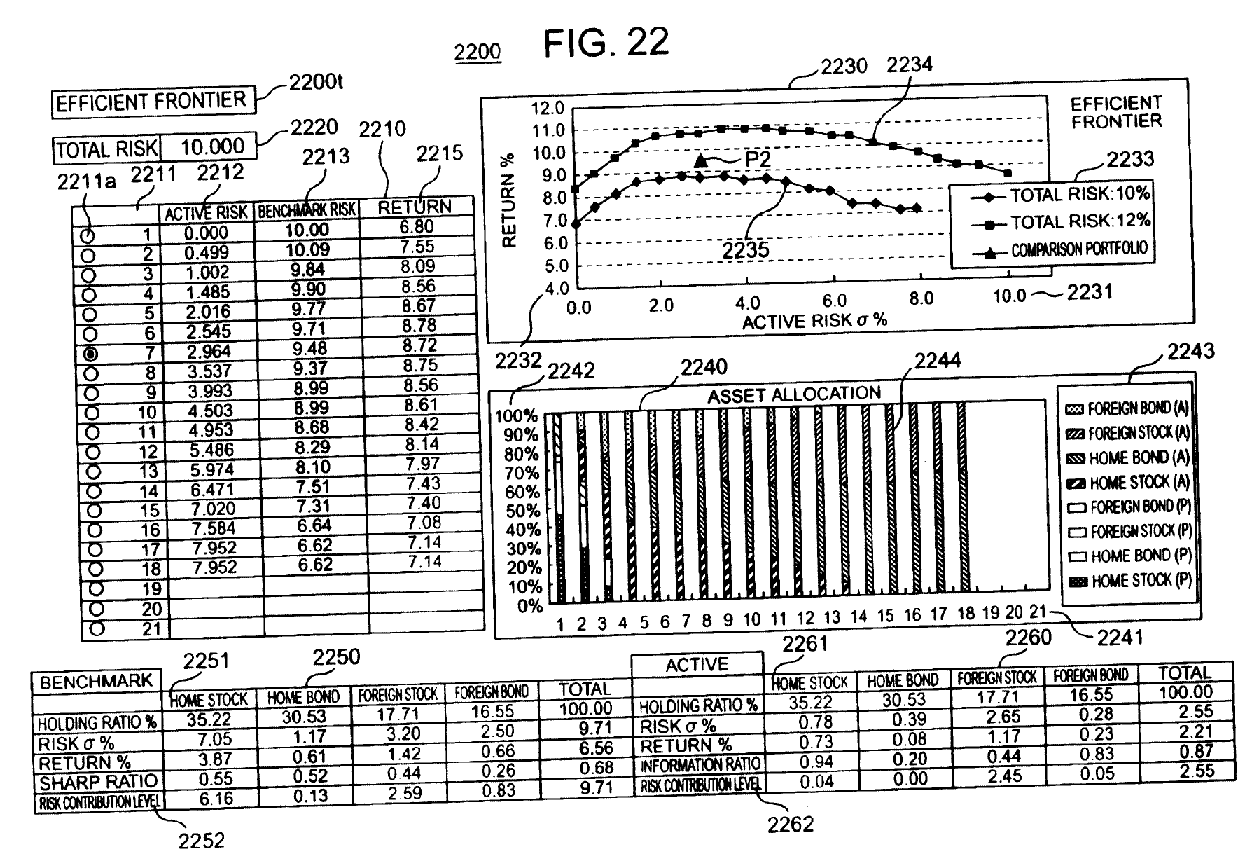

Another embodiment of the portfolio information output screen in the embodiment described above is shown in FIG. 22. On a portfolio information output screen 2200, a table 2210 indicating the relation between total risk risk allocations and returns, a total risk display area 2220 indicating the total risk, an efficient frontier display area 2230 indicating the efficient frontier, an asset allocation area 2240 indicating asset allocation, a benchmark asset detail display area 2250 indicating the details of benchmark assets, and an active management asset detail display area 2260 indicating the details of active management assets are arranged and displayed on the display screen of the display device 32. On the screen, a name 2200t “Efficient frontier” is displayed. This configuration basically corresponds to the table 1010, total risk display area 1020, efficient frontier display area 1030, asset allocation area 1040, benchmark asset detail display area 1050, and active management asset detail display area 1060 shown in FIG. 10 described above.

In the efficient frontier display area 1030, the risk/return relations of different portfolios are compared and displayed. That is, as shown in an explanatory note 2233, two efficient frontiers 2234 and 2235 corresponding to two different total risks are displayed. The point P2 indicates the return for the active risk of the portfolios to be compared. In this way, in this embodiment, risk allocation relations specified by a user entry or one or more risk allocation relations calculated under different conditions may be displayed for comparison.

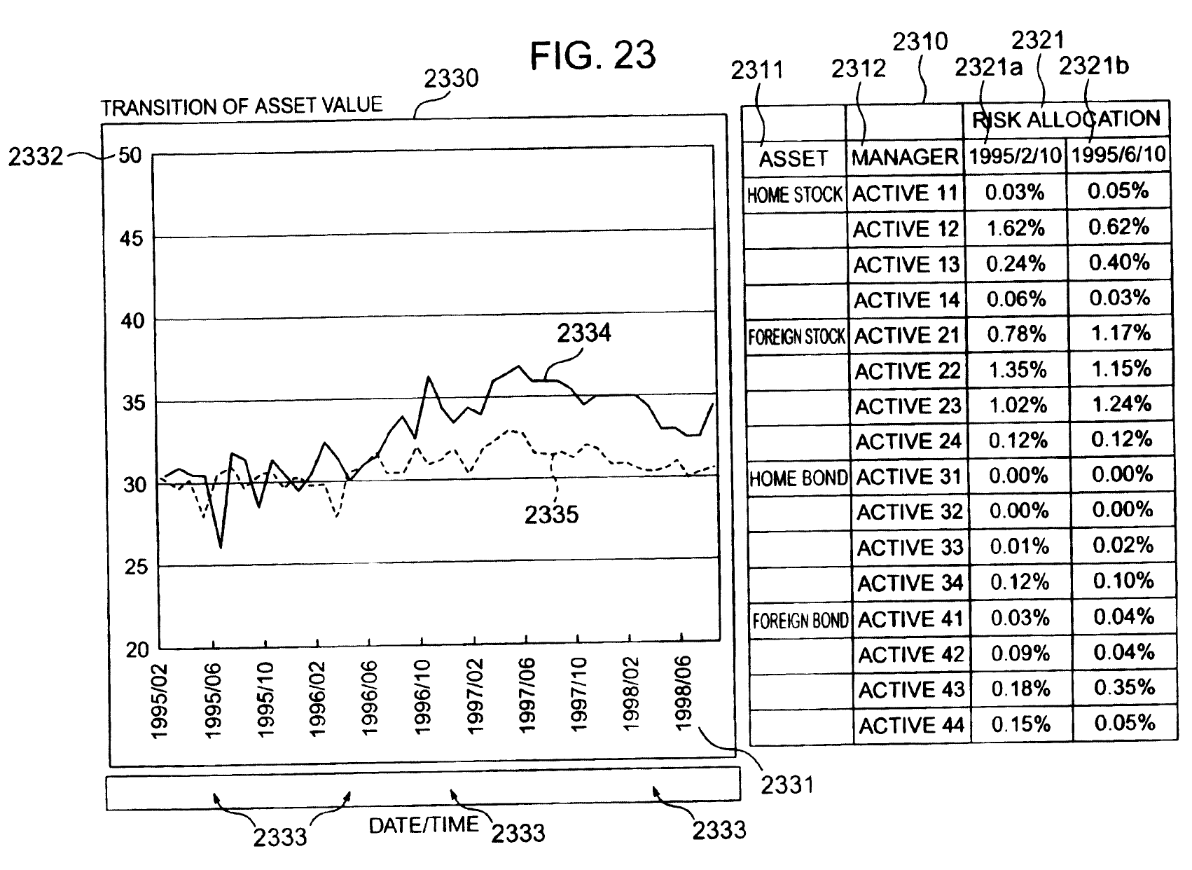

Another example of the output screen output by the asset value simulation result output means will be described with reference to FIG. 23. In FIG. 23, a graph 2330 showing the transition of the portfolio asset value and an optimal risk allocation 2310 for each management type are displayed on the screen. In this example, they are displayed on the same screen. In the graph 2330, the horizontal axis indicates the passage of time 2331 and the vertical axis indicates the asset value 2332. Triangle marks 2333 are displayed below the horizontal axis. Those marks indicate the point of time at which recalculation was executed by applying the rebalance rule described above. In this example, the broken lines 2234 and 2235 indicating the transition of the asset value are shown. The transitions of asset values of portfolios with different risk allocations are displayed so that they can be compared. Here, the broken line 2335 indicates the transition of the asset value of a portfolio to be compared, such as a portfolio created separately by the user or a portfolio used as the benchmark. In addition, the transition of a portfolio asset value, which would be produced by doing rebalancing according to different management plan change rules for the same portfolio or different portfolios, may be displayed.

In the optimal risk allocation 2310, the optimal risk allocation after recalculation at each rebalance time for each active management type is displayed. That is, a manager type 2312 to which an asset 2311 is allocated and a corresponding risk allocation 2321 are displayed. Dates 2321a and 2321b are attached to the risk allocation 2321. In the example in FIG. 23, data on other dates may be viewed by scrolling the screen as in the example shown in FIG. 12.

The configuration described above makes it possible to compare portfolios with different risk allocations or to compare management results produced by applying different management plan change rules to the same portfolio, thus appropriately helping the user in selecting a risk allocation relation or in setting a management plan change rule.

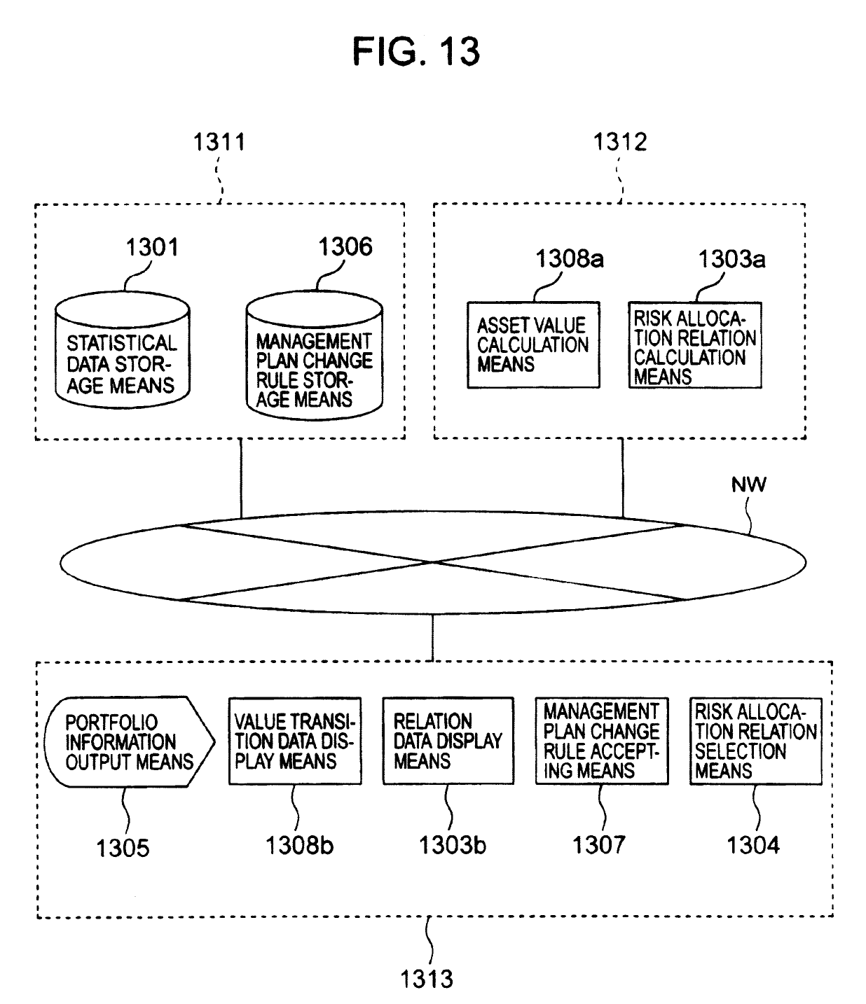

Next, a third embodiment of the present invention will be described. The present invention can support asset management by configuring a system on a network. For example, a plurality of information processors connected to a network NW may be used to build the system configuration in FIG. 3 to provide asset management support services. FIG. 13 shows an example.

The system shown in FIG. 13 comprises statistical data storage means 1301, management plan change rule storage means 1306, asset value calculation means 1308a, risk allocation relation calculation means 1303a, portfolio information output means 1305, value transition data display means 1308b, relation data display means 1303b, management plan change rule accepting means 1307, and risk allocation relation selection means 1304.

When the asset management support system shown in FIG. 13 is compared with the system shown in FIG. 3, there is the correspondence described below. That is, the statistical data storage means 301 corresponds to the statistical data storage means 1301, and the management plan change rule storage means 306 corresponds to the management plan change rule storage means 1306. The portfolio information output means 305 corresponds to the portfolio information output means 1305, the management plan change rule accepting means 307 corresponds to the management plan change rule accepting means 1307, and the risk allocation relation selection means 304 corresponds to the risk allocation relation selection means 1304. The risk allocation relation display means 303 comprises the risk allocation relation calculation means 1303a and the relation data display means 1303b, and the asset value simulation means 308 comprises the asset value calculation means 1308a and the value transition data display means 1308b.

Those means are installed in three devices, for example, a database 1311, an operation processor 1312, and an interface 1313, and are connected to an appropriate network NW such as the Internet. This allows relation data, calculated by the risk allocation relation calculation means 1303a, to be sent to the network NW for display by the relation data display means 1303b. In addition, the value transition data calculated by the asset value calculation means 1308a is sent to the network NW for display by the value transition data display means 1308b.

Next, an embodiment implemented by adding functions to the embodiments described above will be described. In the embodiment described below, functions are added to the system shown in FIG. 1. However, this may be virtually applied also to the system shown in FIG. 3 and the system shown in FIG. 13.

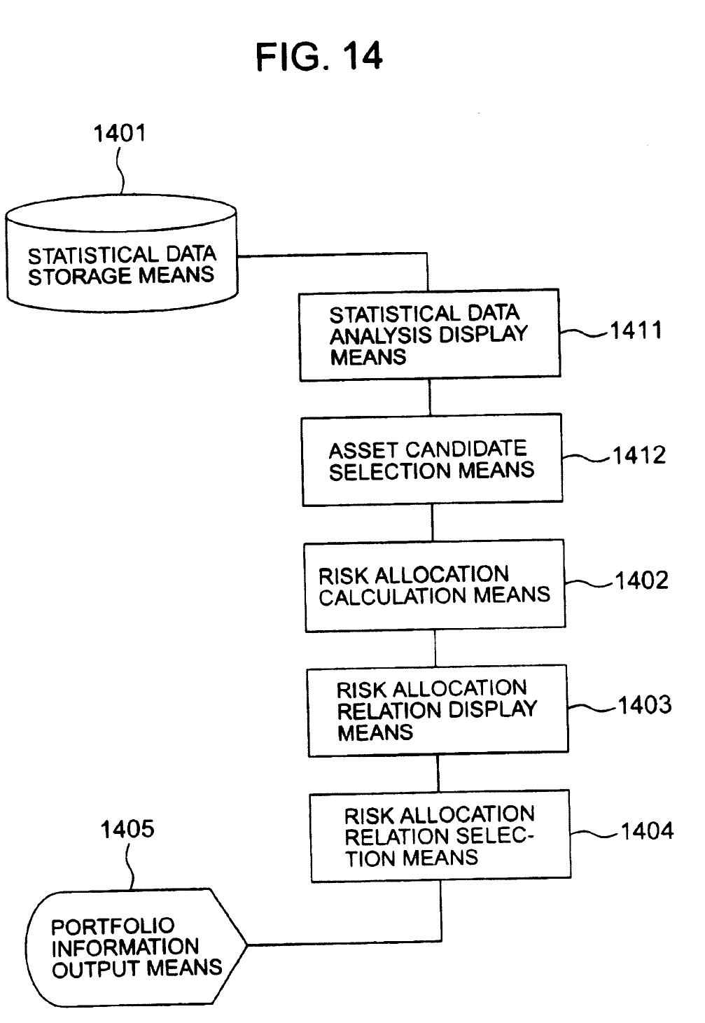

A fourth embodiment according to the present invention will be described with reference to FIG. 14. In this embodiment, statistical data analyze and display means 1411 and asset candidate selection means 1412 are added to the asset management support system shown in FIG. 1. The asset management support system according to the present invention analyzes and displays data stored in statistical data storage means 1401 and, based on the result, selectively receives an asset that will be used as a candidate for risk allocation by risk allocation calculation means 1402.

As shown in FIG. 14, the asset management support system in this embodiment comprises statistical data storage means 1401, statistical data analyze and display means 1411, asset candidate selection means 1412, risk allocation calculation means 1402, risk allocation relation display means 1403, risk allocation relation selection means 1404, and portfolio information output means 1405.

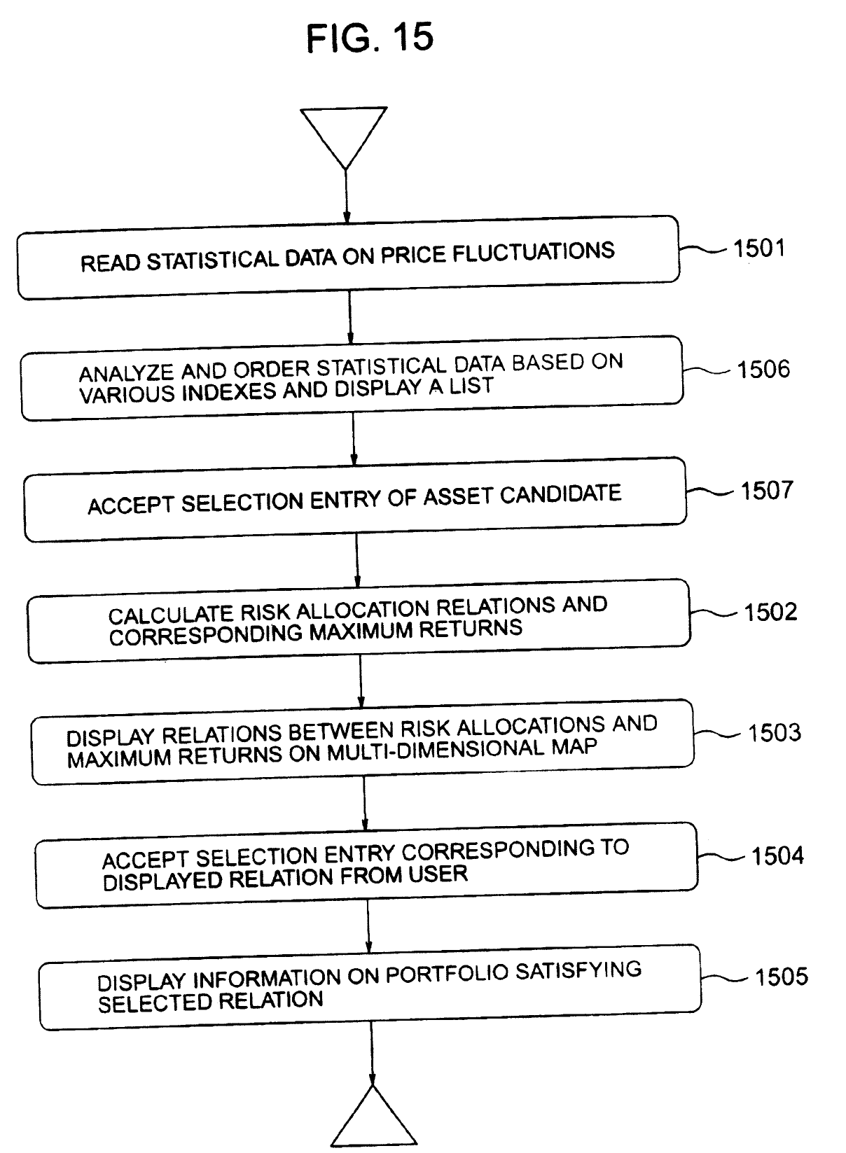

FIG. 15 shows the processing procedure executed by the system in FIG. 14. The steps indicated by numerals 1501-1505 correspond to numerals 101-105 in FIG. 1, and the steps processed by the means indicated by numerals 1401-1405, that is, step 1501-step 1505 in FIG. 15, are the same as the corresponding steps 201-205 in FIG. 2.

The statistical data analyze and display means 1411 analyzes data stored in the statistical data storage means 1401 from various viewpoints, orders the result, and displays the list (step 1506). The asset candidate selection means 1412 accepts a selection entry and passes it to the risk allocation calculation means 1402 (step 1507). The analysis in step 1506 includes, for example, the calculation of the expected return, TE, and IR of a plurality of active managers who are candidates for active management, the correlation coefficients between any two managers, and the correlation coefficients with common indexes. The display in step 1507 is, for example, the display of the list in descending order or ascending order of various value of measures produced as a result of analysis or in ascending order of absolute values.

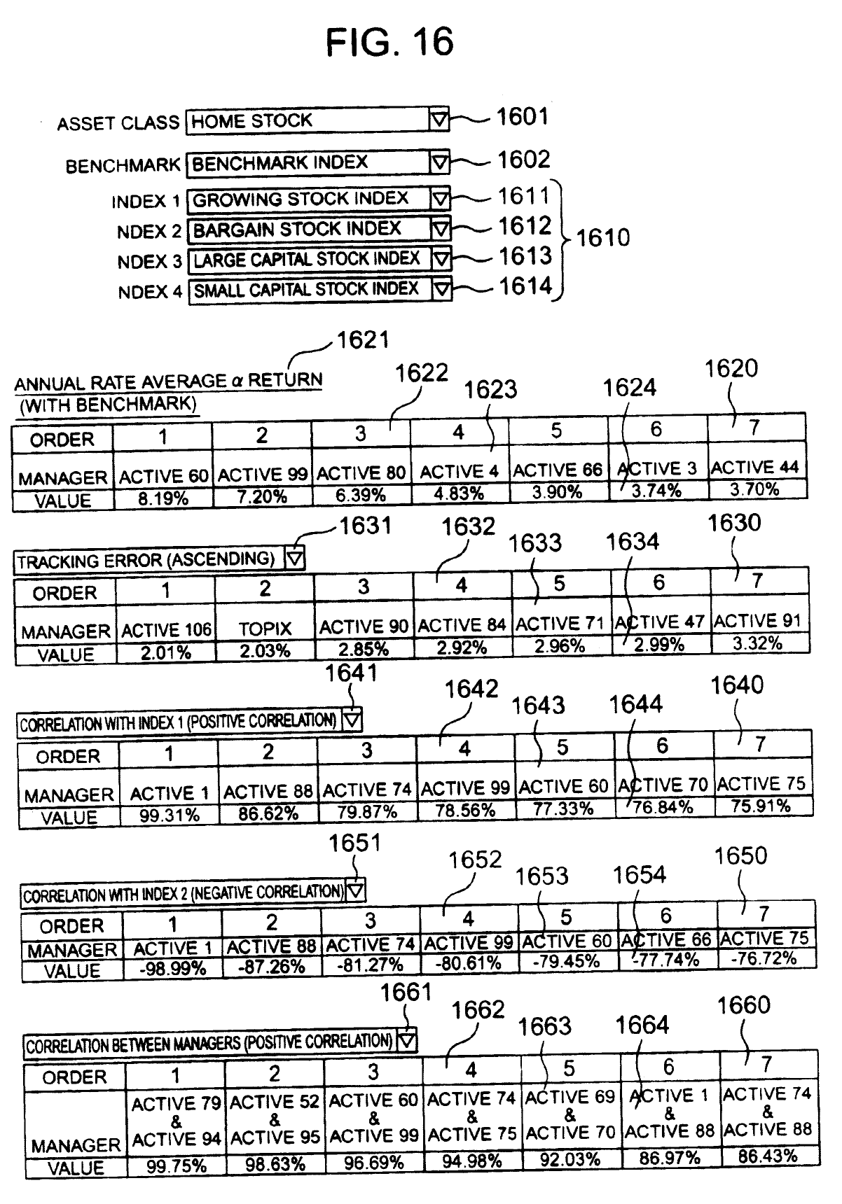

FIG. 16 shows an example of statistical data analysis display. The numeral 1601 indicates an asset to be analyzed. The numeral 1602 indicates the benchmark of the asset. The numerals 1611, 1612, 1613, and 1614 are the common indexes 1610 used for analysis. As common indexes, the user may select an index such as a style index. Those are provided each in the pull-down menu format.

In the display example in FIG. 16, an average annual rate a return (against the benchmark) 1620 and the four display columns 1630-1660 are provided. For the average annual rate a return (against the benchmark) 1620, a title display part 1621 “Average annual rate a return (against the benchmark)” is provided. In this part, the manager names 1623 and the values 1624 indicating corresponding average a returns are displayed with their order 1622. In each of the four display columns, information on an measure selected through the pull-down menu is displayed. That is, the user can select (1608) any analysis result from the analysis results, produced in step 1506, and give an instruction to display the list. In the example in FIG. 16, tracking errors (ascending order) 1630, correlations (positive correlation) with index 1 1640, correlations (positive correlation) with index 2 1650, and correlations between managers (positive correlation) 1660 are displayed. In each display, manager names, values corresponding to the selected measure, and orders are indicated. The user selects an asset candidate based on this analysis result for use as an input to the risk allocation calculation means 1402.

As described above, the statistical data analyze and display means 1411 and the asset candidate selection means 1412 are added in this embodiment. Therefore, data stored in the statistical data storage means 1401 is analyzed and displayed and, based on the result, an asset that will be a risk allocation candidate in the risk allocation calculation means 1402 can be selected for input.

This embodiment may be applied not only to a combination with the system shown in FIG. 1 but also to the system in FIG. 3 and FIG. 13.

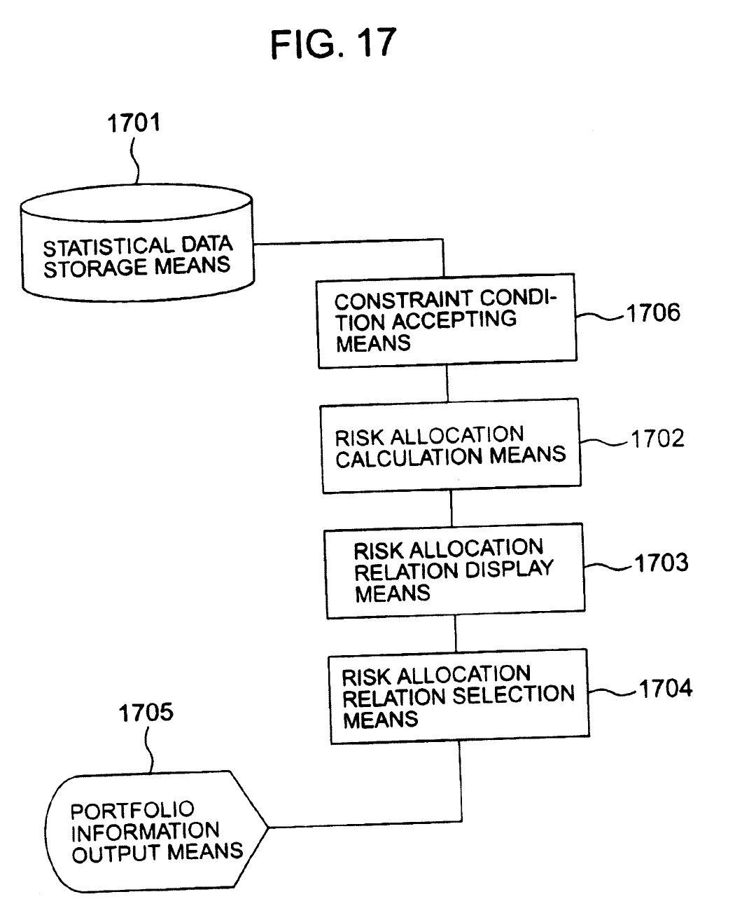

A fifth embodiment of the present invention will be described. This embodiment is an example in which the user may set any constraint for the holding ratio of assets to which risk is to be allocated. FIG. 17 shows an example of system configuration. The example of the system configuration comprises a statistical data storage means 1701, risk allocation calculation means 1702, risk allocation relation display means 1703, and risk allocation relation selection means 1704, which correspond to those in the system configuration in FIG. 1, and further comprises constraint condition accepting means 1706. The means 1701-1705 of the system shown in FIG. 17 correspond to the means 101-105 shown in FIG. 1.

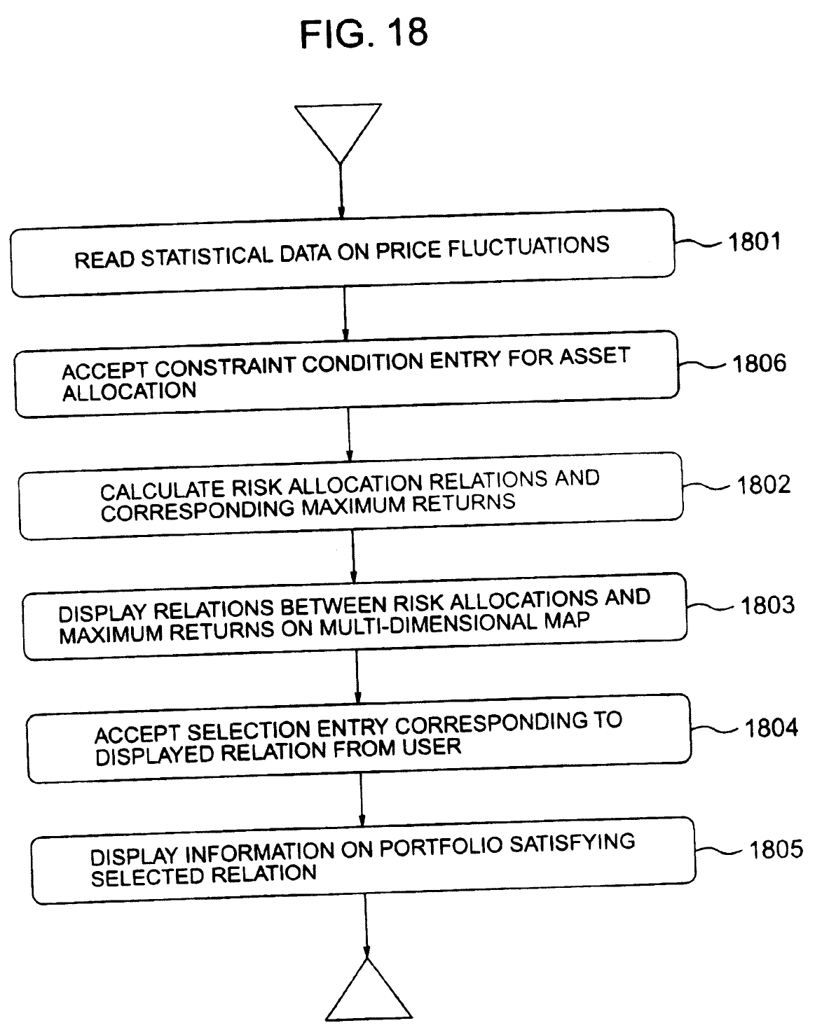

FIG. 18 shows the processing procedure executed by the system in FIG. 17. The procedure steps processed by the means 1701-1705, that is, steps 1801-1805 in FIG. 18, are the same as those of corresponding steps 201-205 in FIG. 2.

The constraint accepting means 1706 accepts (step 1806) the entry of any constraint for the holding ratio of assets to which risk is to be allocated and reflects the constraint on the risk allocation calculation means 1702. An example of constraint is shown in expression (3a) and expression (3b) to expression (5). Expressions (3a) and (3b) are examples of the upper limit and the lower limit of the ratio of investment in each asset to which risk is to be allocated. In expression (3a) and expression (3b), w_{bi} indicates the ratio of investment in each benchmark asset, wₐⱼ indicates the ratio of investment in each active management asset, D_{bi}_{_{—}}_{Low} indicates the lower limit of the ratio of investment in each benchmark asset, D_{bi}_{_{—}}_{Up} indicates the upper limit of ratio of investment in each benchmark asset, Dₐⱼ_{_{—}}_{Low} indicates the lower limit of the ratio of investment in each active management asset, and Dₐⱼ_{_{—}}_{Up} indicates the upper limit of ratio of investment in each active management asset. The investment in each asset is made within the range between the lower limit and the upper limit of the ratio of investment in each asset.

Expression (4) is an example of constraint expression for the mutual relation of ratios of investment in the assets to which risk is to be allocated. In expression (4), W_{b} indicates the investment ratio column vector of benchmark assets, Wₐ indicates the investment ratio column vector of active management assets, C_{b} indicates the coefficient vector of the benchmark asset investment ratios, Cₐ indicates the coefficient vector of active management asset investment ratios, and C₀ indicates a constant term. The investment in each asset is made so that the linear combination of the equality or the inequality of the ratio of investment in each asset, such as that shown in expression (4), may be satisfied. Expression (5) is an example of constraint for the correlation between a portfolio, to which the assets are allocated, and a specific index. In expression (5), ρ_{Portfolio,Index} indicates the coefficient of correlation between the portfolio and a specific index, ρ_{Low} indicates the lower limit of the coefficient of correlation, and σ_{Up} indicates the upper limit of the coefficient of correlation.

Constraint:

D_{bi}_{_{—}}_{Low}≦w_{bi}≦D_{bi}_{_{—}}_{Up} (3a)

Dₐⱼ_{_{—}}_{Low}≦wₐⱼ≦Dₐⱼ_{_{—}}_{Up} (3b)

Constraint:

C′_{bi}w_{bi}+C′ₐⱼwₐⱼ+C₀≦0 (4)

Constraint:

σ_{Low}≦σ_{PortfolioIndex}≦σ_{Up} (5)

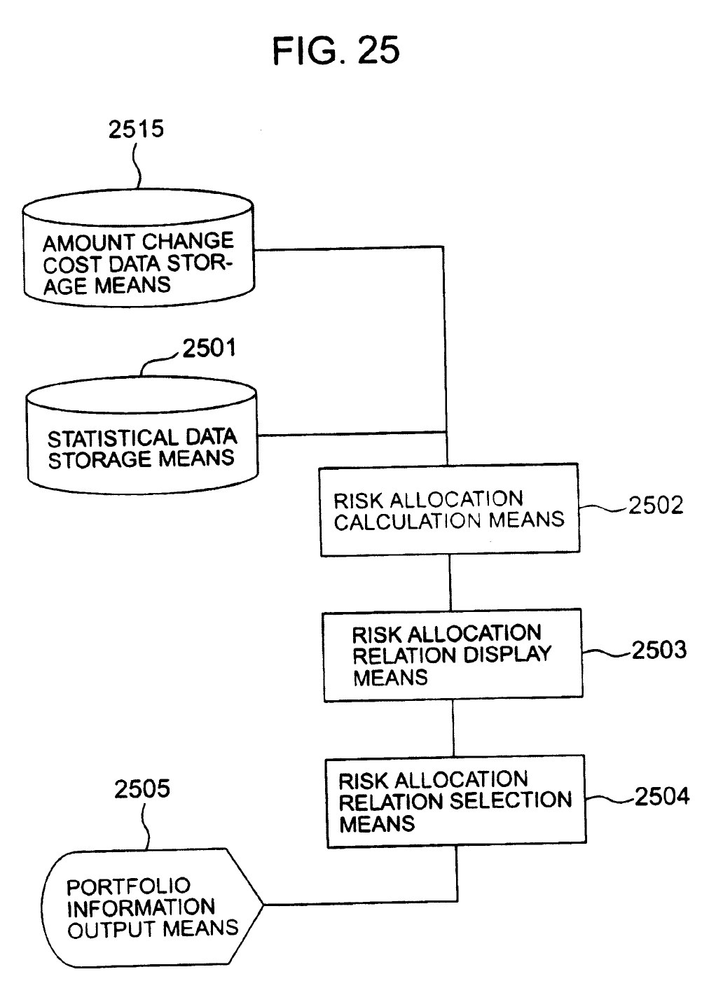

Next, a sixth embodiment of the present invention will be described. In this embodiment, allocation is made considering the cost of change in the amount of the investment assets and in the amount to be allocated to active managers. FIG. 25 shows an example of system configuration.

The system in this embodiment has a configuration similar to the example of system configuration in FIG. 1 to which amount change cost data storage means 2515 is added. The processing procedure executed by the system in FIG. 25 is as shown in FIG. 2. In step 201, statistical data on the price change in the assets is read from statistical data storage means 2501, and the cost required for a change in the management amount is read from the amount change cost data storage means 2515. The maximum expected return calculated in step 202 is the value calculated by subtracting the cost required for the change in the amount from the amount of change in the assets as a result of management (return after cost adjustment).

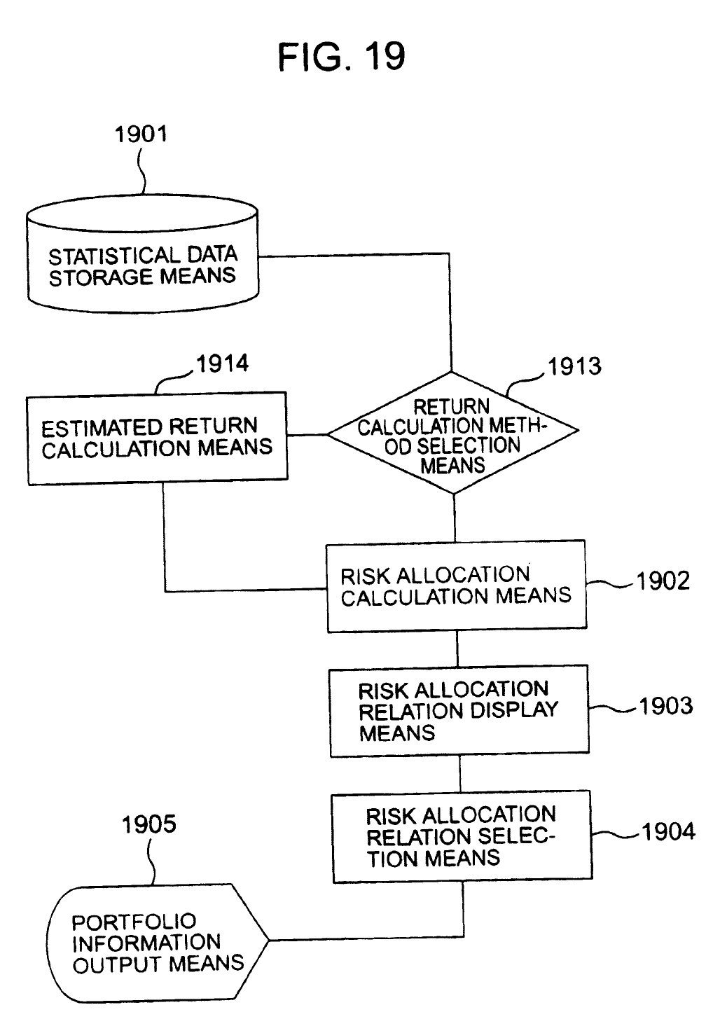

Next, a seventh embodiment of the present invention will be described. In this embodiment, the calculation method for the expected return of the assets to which risk is allocated may be selected. FIG. 19 shows an example of system configuration. The system configuration in the example is similar to that shown in FIG. 1 to which return calculation method selection means 1913 and estimated return calculation means 1914 are added.

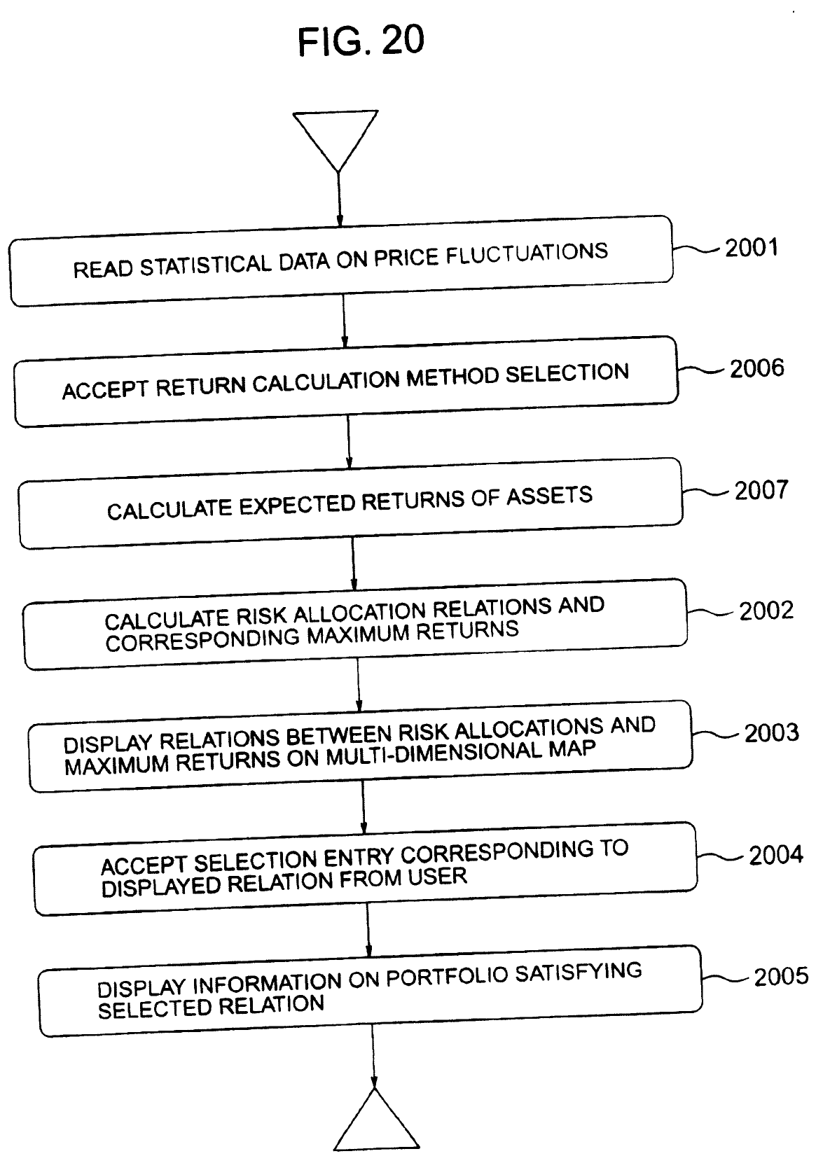

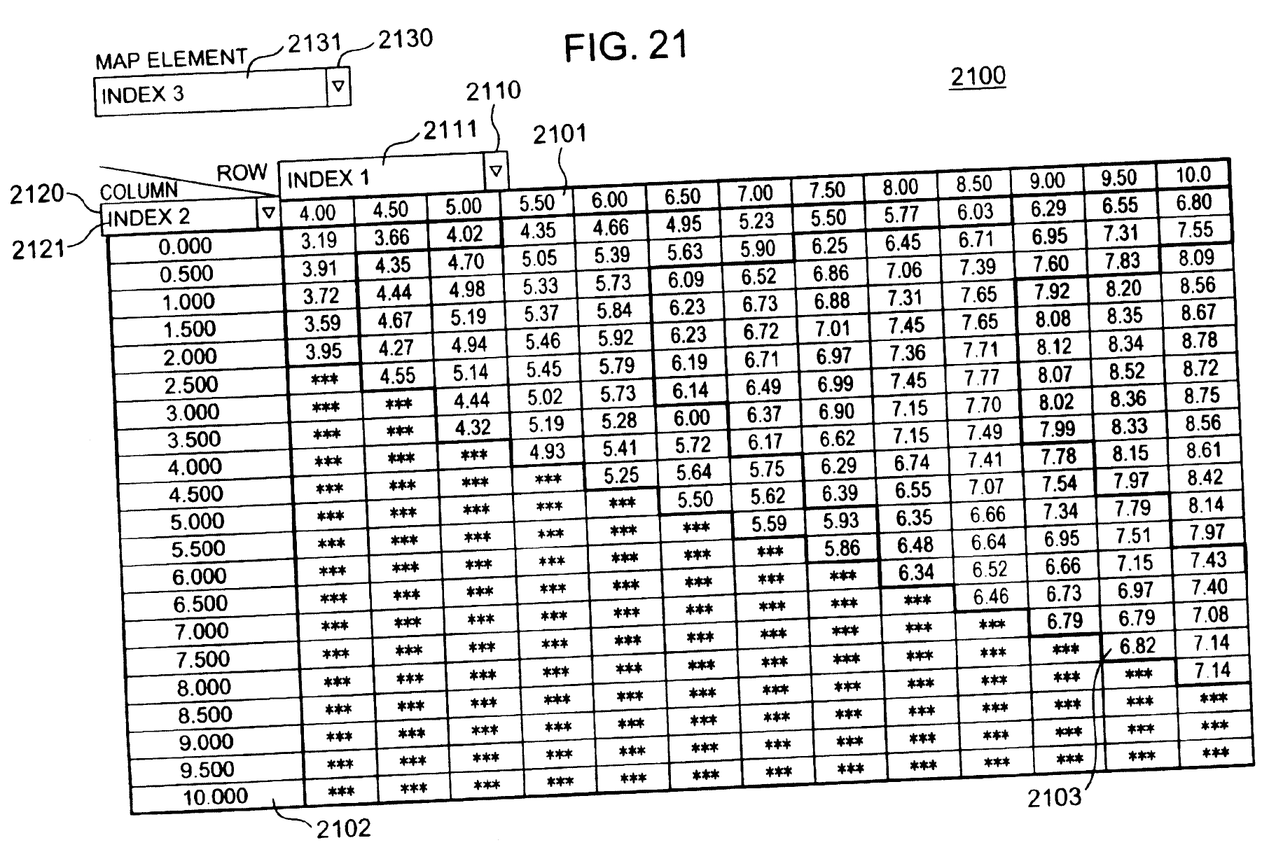

FIG. 20 shows the processing procedure executed by the system in FIG. 19. The means indicated by the numerals 1901-1905 correspond to the means indicated by the numerals 101-105 in FIG. 1, and the steps processed by the means indicated by the numerals 1901-1905, that is, steps 2001-2005 in FIG. 20, are the same as those in the corresponding steps 201-205 in FIG. 2.

The return calculation method selection means 1913 accepts from the user a selection of expected return calculation method for the assets to which risk is allocated (step 2006). When an return estimation calculation is selected, the return estimation calculation means 1914 calculates the estimated return based on financial engineering models such as the building-block method and Black-Litterman method and passes the result to risk allocation calculation means 1902 (step 2007). When no estimated return calculation is selected, the average expected return calculated based on the statistical data is used.

As described above, the present invention, when used in asset management, provides managers with information on the expected maximum return that can be expected by changing risks accepted for various asset types. This gives them a better understanding of the risk/return relation and helps them in reviewing the portfolio composition. The following describe the effects of the embodiments described above.

As described above, a mean variance model requires the user to know or appropriately set the numeric value of his or her own risk tolerance (desired risk/return relation) in advance in order to determine the optimal investment ratios. However, this is not easy in many cases. On the other hand, the system according to the present invention has the risk allocation relation selection display means that gives the user a general overview of the risk allocation relation, the risk allocation relation selection means that allows the user to select a candidate for risk/return relation and provides the user with detailed information, and the asset value simulation means that provides the user with information on the value evaluation of the candidate. Therefore, the system efficiently helps the user to appropriately set the desired risk/return relation described above.

In addition, as described above, asset allocation for benchmark assets in asset allocation stage and the allocation of investment ratio to management after asset allocation mutually affect the risk/return relation. Therefore, if this is done in stages as in the conventional system, it is difficult to form an image consistent between risk and return during repetition/adjustment for creating the optimal management plan considering the relation between the two stages. On the other hand, the risk allocation relation display means allow benchmark asset allocation and active management asset allocation to be made at the same time, because the means calculate a benchmark asset allocation risk or the total risk including it and the expected maximum return with the specified active risk. This makes it easy to create a consistent image from the viewpoint of optimal allocation within the range of an acceptable risk.

As described above, when selecting asset management trustees in practice, there are scores to hundreds of asset management institutions that are candidates for management trustees and therefore it is not realistic to evaluate and study all the combinations of management trustee period for deciding the investment ratio. However, reducing the number of candidates based only on the management result of each management trustee institution involves a danger of compromising the risk distribution effect achieved by combining a plurality of management trustee institutions. By contrast, in the embodiments described above, the asset management result of the candidates is analyzed in advance and, based on the result, the candidates for managers to whom risk is allocated are selected. Therefore, asset allocation may be done efficiently and without compromising the portfolio superiority.

In addition, the risk allocation relation selection means select a candidate for the risk/return relation, and the asset value simulation means perform rebalance simulation through risk allocation. Therefore, as compared with the conventional portfolio evaluation based only on simulation through investment amount allocation, a management plan may be created efficiently from various aspects (for example, risk allocation and investment allocation).

A list of the characteristics of the present invention follows.

1. An asset management support system for use in asset management, wherein the system supports asset management including a decision of asset types and investment ratios thereof and a decision of a detailed method for managing assets, the system comprising risk allocation relation display means for displaying a plurality of risk allocation relations that are relations between risk allocations of formers and latters, dependent on a decision of the formers and a decision of the latters, and returns; risk allocation relation selection means for accepting an entry that selects one or more of the risk allocation relations; and portfolio information output means for outputting portfolio information based on the selected risk allocation relation.

2. The asset management support system as described in 1, further comprising management plan change rule storage means for storing an entered management plan change rule; and asset value simulation means for presenting an asset value transition that would result when the assets are managed based on the management plan change rule.

3. The asset management support system as described in 1, wherein the risk allocation relation display means display relations among benchmark risk allocations, active risk allocations, and returns in a multi-dimensional format, the relations being dependent at least on a decision of asset allocation of benchmark assets and a decision of allocation of benchmark assets that are to be allocated to active management assets.

4. The asset management support system as described in 2, wherein the asset value simulation means presents an asset value transition that would result when rebalancing is done based on the management plan change rule specified for a benchmark asset allocation plan and an active management asset allocation plan satisfying the risk allocation relation selected by a user using the risk allocation relation selection means, the management plan change rule being a management plan change rule based on a change in the risk allocation relation that would result during production run.

5. An asset management support method for use in asset management, comprising the steps of deciding asset types and investment ratios thereof and deciding a detailed method for managing assets, the method comprising the steps of calculating risk allocation relations of formers and latters dependent on a decision of the formers and a decision of the latters and returns of the relations; displaying relations of the risk allocations and the returns in a multi-dimensional map; and allowing a user to select one or more displayed relations.

6. The asset management support method as described in 5, further comprising the steps of accepting a management plan change rule specified for a management plan satisfying the selected risk allocation relation, the management plan change rule being based on a difference between the risk allocation relations and actual risk allocation relations; and presenting an asset value transition that would result when the assets are managed based on the management plan change rule.

7. The asset management support method as described in 5, wherein the decision of the formers and the decision of the latters are a decision of allocation of benchmark assets and a decision of allocation of benchmark assets that are to be allocated to active management assets, the method comprising the steps of calculating benchmark risk allocations and active management risk allocations, dependent on the decision of the formers and the latters, and returns; displaying the relations of the risk allocations and the returns in the multi-dimensional map; and allowing the user to select one or more displayed relations.

8. The asset management support method as described in 6, comprising steps of accepting the management plan change rule, which is based on a change in the risk allocation relations during production run, for a benchmark asset allocation plan and an active management asset allocation plan that satisfy the selected risk allocation relation; and presenting an asset value transition that would result when rebalancing is done based on the management plan change rule.

9. The asset management support method as described in 7, comprising steps of accepting the management plan change rule, which is based on a change in the risk allocation relations during production run, for a benchmark asset allocation plan and an active management asset allocation plan that satisfy the selected risk allocation relation; and presenting an asset value transition that would result when rebalancing is done based on the management plan change rule.

10. The asset management support system as described in 1, wherein the risk allocation relation display means comprise risk allocation relation calculation means and relation data display means, asset value simulation means comprise asset value calculation means and value transition data display means, one or more of the means are composed of a plurality of electronic computers each connected via a network, relation data calculated by risk allocation relation calculation means is sent over the network for display by the relation data display means, and value transition data calculated by the asset value calculation means is sent over the network for display by the value transition data display means.

11. The asset management support system as described in 2, wherein the risk allocation relation display means comprise risk allocation relation calculation means and relation data display means, asset value simulation means comprise asset value calculation means and value transition data display means, one or more of the means are composed of a plurality of electronic computers each connected via a network, relation data calculated by risk allocation relation calculation means is sent over the network for display by the relation data display means, and value transition data calculated by the asset value calculation means is sent over the network for display by the value transition data display means.

12. The asset management support method as described in 5, wherein either risk allocation amounts individually owned by the asset types or risk contributions of the asset types that, when added, form the total risk of a portfolio are used as indexes representing a risk allocation state.

13. The asset management support method as described in 12, wherein the standard deviation of return fluctuations or asset value fluctuations, VaR, C-VaR, EaR, or shortfall probability is used as an index representing a risk.

14. A program executing the steps of the asset management support method as described in 5 on a computer.

15. A program executing the steps of the asset management support method as described in 6 on a computer.

16. A computer readable recording medium recording therein a program executing the steps of the asset management support method as described in 5 on a computer.

17. A computer readable recording medium recording therein a program executing the steps of the asset management support method as described in 6 on a computer.

18. The asset management support system as described in 1, wherein the decision of the formers and the decision of the latters are a decision of allocation of benchmark assets and a decision of allocation of benchmark assets that are to be allocated to active management assets, the system further comprising means for analyzing management results of a plurality of active management assets, which are candidates for the active management assets, for displaying them as a list; and means for selecting active management assets, to which allocation is made, for use as input information to risk allocation calculation means.

19. The asset management support system as described in 1, further comprising constraint condition accepting means for accepting a constraint condition on the allocation of the formers and the latters.

20. The asset management support system as described in 1, further comprising means for selecting a calculation method, which is used in the step of calculating returns, for calculating expected return values of benchmark assets and active management assets; and means for calculating estimated expected returns using a financial model based on actual management results of the benchmark assets and the active management assets

21. The asset management support method as described in 1, further comprising means for storing data on costs of changes in an amount, wherein the returns are profits from which the costs of changes in the amount have been subtracted.

22. The asset management support system as described in 1, wherein the risk allocation relation display means comprise a switching function that displays a relation between at least two of the risk allocations or return indexes and at least one of the risk allocations or return indexes corresponding to the combination in a multi-dimensional format and switches the combination of the risk allocations or return indexes displayed in the multi-dimensional format.

23. The asset management support system as described in 1, wherein the risk allocation relation display means comprise a function that displays a user-entered risk allocation relation or a risk allocation relation calculated under different conditions for comparison.

24. The asset management support system as described in 4, the asset value simulation means comprise a function that displays asset value transitions for comparison when rebalancing is done based on a different user-entered asset allocation plan or a different management plan change rule.

25. The asset management support method as described in 5, further comprising the steps of analyzing and displaying management results of active management assets that are candidates for the allocation of the latters; selecting a candidate based on the analysis result; and passing the selected candidate to the step of deciding an allocation ratio.

26. The asset management support method as described in 5, further comprising the constraint condition accepting step of accepting a constraint condition for the allocation of the formers and the latters.

27. The asset management support method as described in 5, further comprising the steps of electing a return calculation method; and calculating an estimated return.

28. The asset management support method as described in 5, wherein the returns are a rate of change in a difference between total assets and total debts and the allocated risks include fluctuation risks of the returns.

According to the embodiments of the present invention, the decision of asset types and investment ratios thereof and the decision of a detailed method for managing assets may be efficiently made in asset management while considering a change in the risk allocation relations in formers and latters.

Although the embodiments have been described above, it is apparent to those skilled in the art that the present invention is not limited to those embodiments but may be changed and modified without departing from the spirit of the present invention or scope of the claims.

What is claimed is:

1. An asset management support system for use in set management, wherein said system supports asset management including a decision of asset types and investment ratios thereof and a decision of a detailed method for managing assets, said system comprising:
risk allocation relation display means for displaying a plurality of risk allocation relations that are relations between risk allocations of formers and latters, dependent on a decision of the formers and a decision of the latters, and returns;
risk allocation relation selection means for accepting an entry that selects one or more of the risk allocation relations; and
portfolio information output means for outputting portfolio information based on the selected risk allocation relation.

2. The asset management support system according to claim 1, further comprising management plan change rule storage means for storing an entered management plan change rule; and asset value simulation means for presenting an asset value transition that would result when the assets are managed based on the management plan change rule.

3. The asset management support system according to claim 1, wherein said risk allocation relation display means display relations among benchmark risk allocations, active risk allocations, and returns in a multi-dimensional format, said relations being dependent at least on a decision of asset allocation of benchmark assets and a decision of allocation of benchmark assets that are to be allocated to active management assets.

4. The asset management support system according to claim 2, wherein said asset value simulation means presents an asset value transition that would result when rebalancing is done based on the management plan change rule specified for a benchmark asset allocation plan and an active management asset allocation plan satisfying the risk allocation relation selected by a user using the risk allocation relation selection means, said management plan change rule being a management plan change rule based on a change in the risk allocation relation that would result during production run.

5. An asset management support method for use in asset management, comprising the steps of deciding asset types and investment ratios thereof and deciding a detailed method for managing assets, said method comprising the steps of:
calculating risk allocation relations of formers and latters dependent on a decision of the formers and a decision of the latters and returns of the relations; displaying relations of the risk allocations and the returns in a multi-dimensional map; and allowing a user to select one or more displayed relations.

6. The asset management support method according to claim 5, further comprising the steps of accepting a management plan change rule specified for a management plan satisfying the selected risk allocation relation, said management plan change rule being based on a difference between the risk allocation relations and actual risk allocation relations; and presenting an asset value transition that would result when the assets are managed based on the management plan change rule.

7. The asset management support method according to claim 5, wherein the decision of the formers and the decision of the latters are a decision of allocation of benchmark assets and a decision of allocation of benchmark assets that are to be allocated active management assets, said method comprising the steps of calculating benchmark risk allocations and active management risk allocations, dependent on the decision of the formers and the latters, and returns; displaying the relations of the risk allocations and the returns in the multi-dimensional map; and allowing the user to select one or more displayed relations.

8. The asset management support method according to claim 6, comprising steps of accepting the management plan change rule, which is based on a change in the risk allocation relations during production run, for a benchmark asset allocation plan and an active management asset allocation plan that satisfy the selected risk allocation relation; and presenting an asset value transition that would result when rebalancing is done based on the management plan change rule.

9. The asset management support method according to claim 7, comprising steps of accepting the management plan change rule, which is based on a change in the risk allocation relations during production run, for a benchmark asset allocation plan and an active management asset allocation plan that satisfy the selected risk allocation relation; and presenting an asset value transition that would result when rebalancing is done based on the management plan change rule.

10. The asset management support system according to claim 1, wherein said risk allocation relation display means comprise risk allocation relation calculation means and relation data display means, asset value simulation means comprise asset value calculation means and value transition data display means, one or more of the means are composed of a plurality of electronic computers each connected via a network, relation data calculated by risk allocation relation calculation means is sent over the network for display by said relation data display means, and value transition data calculated by said asset value calculation means is sent over the network for display by said value transition data display means.

11. The asset management support system according to claim 2, wherein said risk allocation relation display means comprise risk allocation relation calculation means and relation data display means, asset value simulation means comprise asset value calculation means and value transition data display means, one or more of the means are composed of a plurality of electronic computers each connected via a network, relation data calculated by risk allocation relation calculation means is sent over the network for display by said relation data display means, and value transition data calculated by said asset value calculation means is sent over the network for display by said value transition data display means.

12. The asset management support method according to claim 5, wherein either risk allocation amounts individually owned by the asset types or risk contributions of the asset types that, when added, form the total risk of a portfolio are used as measures representing a risk allocation state.

13. The asset management support method according to claim 12, wherein the standard deviation of return fluctuations or asset value fluctuations, VaR, C-VaR, EaR, shortfall probability, SaR, or factor exposure is used as an measure representing a risk.

14. A program executing the steps of the asset management support method according to claim 5 on an electronic computer.

15. A program executing the steps of the asset management support method according to claim 6 on an electronic computer.

16. A computer readable recording medium recording therein a program executing the steps of the asset management support method according to claim 5 on an electronic computer.

17. A computer readable recording medium recording therein a program executing the steps of the asset management support method according to claim 6 on an electronic computer.

18. The asset management support system according to claim 1, wherein the decision of the formers and the decision of the latters are a decision of allocation of benchmark assets and a decision of allocation of benchmark assets that are to be allocated to active management assets, said system further comprising means for analyzing management results of a plurality of active management assets, which are candidates for the active management assets, for displaying them as a list; and means for selecting active management assets, to which allocation is made, for use as input information to risk allocation calculation means.

19. The asset management support system according to claim 1, further comprising constraint accepting means for accepting a constraint on the allocation of the formers and the latters.

20. The asset management support system according to claim 1, further comprising means for selecting a calculation method, which is used in the step of calculating returns, for calculating expected return values of benchmark assets and active management assets; and means for estimating expected returns using a financial model based on actual management performance of the benchmark assets and the active management assets.

21. The asset management support method according to claim 1, further comprising means for storing data on costs of changes in an amount of assets in which investment is to be made and in an amount to be allocated to active managers, wherein the returns are profits from which the costs of changes in the amount have been subtracted.

22. The asset management support system according to claim 1, wherein said risk allocation relation display means comprise a switching function that displays a relation between at least two of the risk allocations or return measures and at least one of the risk allocations or return measures corresponding to the combination in a multi-dimensional format and switches the combination of the risk allocations or return measures displayed in the multi-dimensional format.

23. The asset management support system according to claim 1, wherein said risk allocation relation display means comprise a function that displays a user-entered risk allocation relation or a risk allocation relation calculated under different conditions for comparison.

24. The asset management support system according to claim 4, said asset value simulation means comprise a function that displays asset value transitions for comparison when rebalancing is done based on a different user-entered asset allocation plan or a different management plan change rule.

25. The asset management support method according to claim 5, wherein the decision of the formers and the decision of the latters are a decision of allocation of benchmark assets and a decision of allocation of benchmark assets that are to be allocated to active management assets, said method further comprising the steps of analyzing and displaying management results of active management assets that are candidates for the allocation of the latters; selecting a candidate based on the analysis result; and passing the selected candidate to the step of deciding an allocation ratio.

26. The asset management support method according to claim 5, further comprising the constraint accepting step of accepting a constraint for the allocation of the formers and the latters.

27. The asset management support method according to claim 5, further comprising the steps of selecting a return calculation method; and estimating a return.

28. The asset management support method according to claim 5, wherein the returns are a rate of change in a difference between total assets and total debts and the allocated risks include fluctuation risks of the returns.

29. An asset management support system comprising a computer executing operation processing; a storage unit storing therein programs and data; and a user interface displaying a processing result to a user and accepting an instruction entry from the user,
wherein said storage unit defines a plurality of portfolios with different risk allocations by varying an asset investment ratio of assets in the portfolios for asset management, relates risk allocations decided at that time with expected returns calculated for each portfolio, and stores them,
wherein said computer causes said user interface to visually display relations between stored risk allocations and returns, and
wherein, in response to an entry that selects displayed risk allocations via said user interface, said computer causes said user interface to display portfolio information on the selected risk allocations.
